(19) United States
(12) Patent Application Publication
(10) Pub. No.: US 2006/0167670 A1
(43) Pub. Date: Jul. 27, 2006

(54) Photon-based modeling of the human eye and visual perception

(76) Inventor: Michael F. Deering, Los Altos, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/341,091

(22) Filed: Jan. 26, 2006

Related U.S. Application Data
(60) Provisional application No. 60/647,494, filed on Jan. 26, 2005.

(51) Int. Cl. G06G 7/48; G06G 7/58

(52) U.S. Cl. 703/11

(57) ABSTRACT

A photon-based model of individual cones in the human eye perceiving images on digital display devices is presented. Playback of streams of pixel video data is modeled as individual photon emission events from within the physical substructure of each display pixel. The generated electromagnetic wavefronts are refracted through a four surface model of the human cornea and lens, and diffracted at the pupil. The characteristics of each of several million photoreceptor cones in the retina are individually modeled by a synthetic retina model. Photon absorption events map the collapsing wavefront to photon detection events in a particular cone, resulting in images of the photon counts in the retinal cone array. The rendering systems used to generate sequences of these images account for wavelength dependent absorption in the tissues of the eye and the motion blur caused by slight movement of the eye during a frame of viewing.

### CROSS-REFERENCE TO RELATED APPLICATION(S)

This application claims priority under 35 U.S.C. §119(e) to U.S. Provisional Patent Application Ser. No. 60/647,494, “Photon-based Modeling of the Human Eye and Visual Perception,” filed Jan. 26, 2005. The subject matter of the foregoing is incorporated herein by reference in its entirety.

### BACKGROUND OF THE INVENTION 1. Field of the Invention

This invention relates to simulations of the human eye and visual perception, including for example simulating the interaction of physical display devices with the human eye. Related applications can involve the fields of image acquisition, synthetic image rendering, processing and displays, specifically including physical display devices.

2. Description of the Related Art

All applications of computer graphics and displays have a single ultimate end consumer: the human eye. While enormous progress has been made on models for rendering graphics, much less corresponding progress has been made on models for showing what the eye actually perceives in a given complex situation. Now that technological advances have allowed display devices to meet or exceed the requirements of the human visual system in parts, a new design goal for displays is, to understand where these limits need no longer be pushed, and where display devices are still lacking. Current models of visual perception may be inadequate to achieve this purpose.

For example, the resolution perceived by the eye involves both spatial and temporal derivatives of the scene. Even if the image is not moving, the eye is moving (“drifts”), but previous attempts to characterize the resolution requirements of the human eye generally have not taken this into account. Other work in this area has also had related shortcomings. [Deering 1998] tried to characterize the resolution limits of the human eye as when the display pixel density matches the local cone density. Unfortunately, this simple approximation can understate the resolution requirements in the fovea, where more pixels than cones may be needed, and overstate the resolution limits in the periphery, where large receptor fields rather than cones are the limit. Looking at this another way, there are five million cones in the human eye, but only half a million receptor field pairs outputting to the optic nerve. In [Barsky 2004] a system was described in which a particular person's corneal shape data is used to produce retinal images, though chromatic effects are not included.

What is needed is a system using a combination of computer graphics rendering techniques and known anatomical and optical properties of the human eye to produce a much finer grain simulation of the image forming process: a photon accurate model of the human eye. Having an accurate, quantitative deep model of the human visual system and its interaction with modern rendering and display technology would be desirable to achieve this new design goal for displays.

### BRIEF DESCRIPTION OF THE DRAWING

The invention has other advantages and features which will be more readily apparent from the following detailed description of the invention and the appended claims, when taken in conjunction with the accompanying drawing, in which:

FIG. 1 is a block diagram of a system including one embodiment of the present invention.

FIG. 2 is a modified version of the Escudero-Sanz schematic eye.

FIG. 3 is an illustration of three neighboring foveal cones.

### SUMMARY OF THE INVENTION

In one aspect, the present invention overcomes the limitations of the prior art by using a model of the human eye and/or visual perception that is based on discrete light propagation events. For example, in one embodiment, the model can potentially simulate every photon event that passes from a display being simulated into the human eye, uniquely in space and time. As a result, significant interactions between temporal properties of the physical display device and the human visual system can be properly modeled and understood. This is advantageous because the human eye is continuously in motion, even during the brief periods when physical image display devices are forming parts of a pixel during a single frame time. The eye's continuous motion is part of how it perceives the world. The eye's motion is used in part to detect various types of motion and objects. If a display technology interferes with this process, this may result in a decrease in image quality.

In one example application, display designs are simulated on a photon by photon basis. Each simulated photon emission event is characterized by three values: the specific point in 3D space on which it was emitted in the simulated display surface; the particular time (with sub-frame time accuracy) that it was emitted, and at what wavelength of light it was emitted.

Given a sufficiently precise emission time, the precise position and orientation of the simulated eye due to simulated movement effects can be calculated. The simulated movement effects can include movement of the display, of the viewer's body, of the viewer's torso with respect to their body, of the viewer's head with respect to their torso, and of the viewer's eyes with respect to their head. The movement of the viewer's eyes can include rotations due to saccades, pursuit movements, microsaccades, slow drifts, and tremor. The sum of all this allows the precise geometry of the entry of the specific simulated photon into the simulated eye to be computed.

The photon, represented as a wavefront, is simulated progressing through the optical elements of the simulated eye, and if not otherwise absorbed, eventually generating a probability density field on the surface of the retina representing where this particular photon may materialize. Such simulations are useful in better designing all of the components of the imaging pipeline, from image acquisition and rendering, image processing, to image display.

Other aspects of the invention may include a system for the simulation of the design of image capture devices, computer graphics rendering systems, post-production hardware and software systems and techniques, image compression and decompression techniques, display devices and their associated image processing, specifically including image scaling, frame rate and de-interlacing conversion, pixel pre-processing, and compensation for a number of effects including geometric and chromatic distortion, projection screen characteristics, etc. Other aspects of the invention may further include methods in combination involving the discrete simulation of emitted photons from a display device through a model of the human eye including fine rotations, simulation of foveal cone shape, size, locations, and distributions throughout the retina, and simulations of the diffraction of light at the iris and at the individual cone apertures, the conversion of these photon probability events into photon counts at cones in the retina, and simulation of several more layers of neural circuitry to model the perception of edges and other visual properties of the images being displayed (vs. as seen in the real world).

### DETAILED DESCRIPTION OF THE PREFERRED EMBODIMENTS

### A. An Overview of a Complete Rendering/Imaging, Display, Optics & Perception System

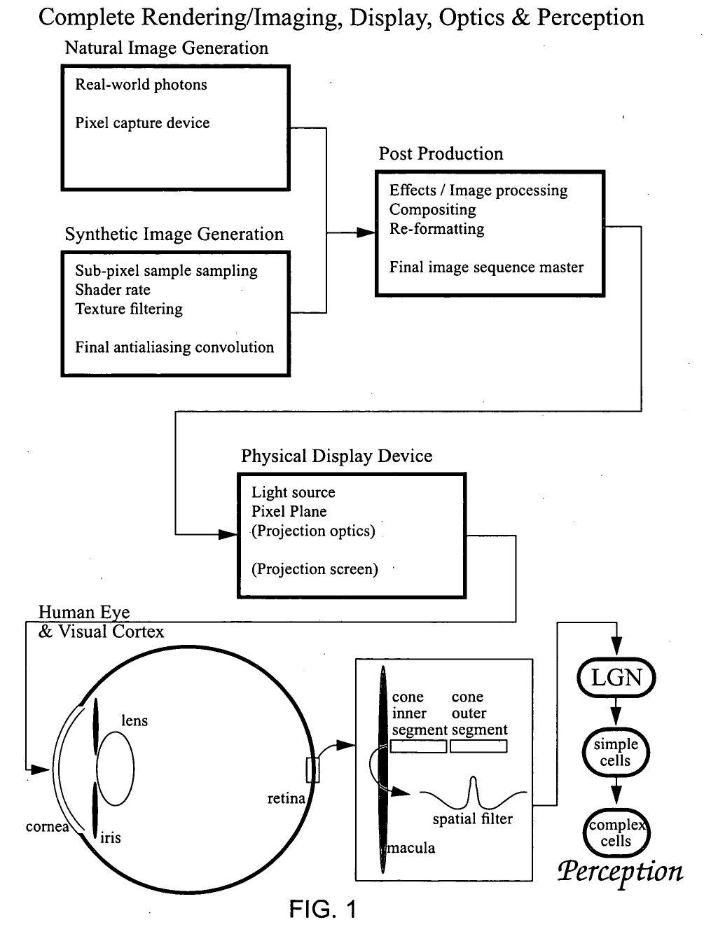

FIG. 1 is a block diagram of a system including one embodiment of the present invention. The following discusses each of the elements in FIG. 1 in turn.

### 1. Natural Image Generation

Natural image generation is the process of gathering sequences of images from photons in the physical world. Natural image generation devices include both film and electronic cameras. Electronic cameras employ any of a variety of pixel capture elements, including video imaging tubes (plumbicons, etc.), CCD (charge coupled devices) imagers, CMOS (Complementary Metal Oxide on Silicon) imagers, and pin diode arrays.

### 2. Synthetic Image Generation

Synthetic image generation is the process of generating sequences of images using computational processes, either in hardware, software, or both. This process may be real-time, as in the case of flight simulators or video games, or batch, as in the case of most computer animated movies. This computational process may use as inputs images or image sequences, which may have themselves been generated either naturally or synthetically.

### 3. Post Production

Post production traditionally refers to the operations performed on an image sequence between its generation and its transmission to a physical display device. In the case of the production of traditional motion pictures, this has moved from simple editing of film and sound tracks, to complex computer based effects and blending of both natural and synthetic imagery. In this description, post production will refer to the more general set of operations that can take place between image generation and physical device display, either in real-time or not. Under this definition, post production includes potential compression/decompression and/or encryption/decryption of image sequences and color space conversion.

### 4. Physical Image Display Devices

Physical image display devices include any device capable of displaying still or moving images from an image source. Common direct view image display devices include CRTs (Cathode Ray Tubes), LCDs (Liquid Crystal Displays), Plasma displays, LED (Light Emitting Diode) displays, OLED displays (Organic Light Emitting Diode) displays, and electronic ink displays. Direct view displays typically either directly emit photons from their display elements, (CRT, Plasma, LED, OLED), or employ a backlight (LCD), or ambient room light (liquid ink). Examples of still devices include film, slide projectors, laser printers and inkjet printers.

Common projection based display devices include CRT projectors, LCD projectors, DLP (Digital Light Projector) projectors, LCOS (Liquid Crystal On Silicon) displays, diffraction based pixel projectors, scanning LED projectors, and scanning laser projectors. Projectors commonly employ a light source, optics to bring the light to the display pixel forming elements, optics to bring the light out of the device, and either a front or rear screen to form an image in space. Alternatively, displays such as virtual retinal displays form images directly on the retina of the human eye. Some projectors combine three or more different color pixel forming elements to make a colored display. Others run at high frame rates and employ the equivalent of a color wheel to make a field sequential color display. Others use a combination of different color pixel forming elements and field sequential color display.

The goal of physical image display devices typically is to produce an image in the human eye, trading off issues of image quality for cost, weight, brightness, contrast, frame rate, portability, safety, ambient light environments, color gamut, and compatibility against each other.

### 5. Human Visual Perception of Natural and Artificial Visual Worlds

Humans perceive the visual world around them (including images formed by physical display devices) by photons entering their eyes, creating dynamic images within the photoreceptor cells of the eye's retina.

In the natural world, photons enter human eyes based on reflections of photons from sunlight and artificial light reflecting off objects; the intensity of the reflection depending on many factors, prominently including properties of the objects including selective absorption of frequencies of photons (“colored objects”), and the relative angles of the illumination, the object, and the observer's eye.

In the artificial case of a human viewing image sequences on a physical display device, perception is still caused by photons entering the human eye, but how the photons are generated is quite different. The intensities and relative colors of photons are largely pre-determined where the image sequence was created elsewhere, either by natural image generation, including film and electronic cameras, or synthetic image generation, including computer graphics rendering, or by some combination of these, including post-production effects. The physical photons are produced dynamically by the image display device as indicated by the (now mostly digital) information in the video image sequence. The physical display device may also add its own forms of post production effects to the images before generating photons.

However, the retinal images created by even the most advanced image display devices generally do not match the quality of those created by the real world. There are many reasons for this. Thus in order to construct better natural and synthetic image generators, post-production effects, as well as better image display devices, it is desirable to have a better model of how photons entering the eye in natural and artificial viewing conditions produce retinal images.

### 6. Eye and Visual Perception Models

In one eye model, photon generation from a display device is simulated. The simulated photons are propagated through the eye model to the receptor field (cones in this example, but other models could also include rods or combinations of rods and cones). Various optical effects (such as focusing, absorption and diffraction) are modeled as affecting the probability density function describing where/whether a photon will be incident on the retina and/or be absorbed by the cone on which the photon is incident.

In one aspect, a biologically accurate grid of cone cells is “grown” by simulation. This grid of perturbed cone cells samples the incident photon flux. The photon's interaction with a cone is computed, possibly resulting in the photon starting a chemical cascade within the cone eventually resulting in the perception of light. Layers of retinal circuitry beyond the cone can also be simulated, representing more of the deep model of how the simulated display effects perception by a human viewer. Similarly, the effects of the LGN and simple and complex cells of the human visual cortex can also be simulated. For many applications, the visual perception model can be stopped at this point, as opposed to simulation deeper into the visual cortex. This level of simulation is good enough for most purposes of understanding the effects of display design compromises.

Using such a model, known display defects that can be simulated may include errors in or due to: resolution, acuity, color, contrast, focus, motion blur, general blurriness, depth of field, vergence, black level, “jaggies”, pixilation effects, flickering, motion, stuttering, mach banding, grain effects, stereo miscues, simulator sickness, and those involved in the usage of foveal-peripheral displays.

In another aspect of the invention, not all eyes are alike, so to properly characterize a display device, simulation may have to be done with a range of representative parameterized eyes. In certain cases, such as real-time simulation or advanced home entertainment, when there is just one known viewer, a model of an eye parameterized specifically to that particular viewer (the shape and quality and spectral absorption and scatter of the cornea and lens, iris de-centering, macular thickness and absorption, foveal cone density, visual tested physiological resolution limits, specific genetic photo-pigment spectral absorption curves, etc.) can be used to customize the synthesized images and/or the display of images.

### B. A Model of Displays and the Human Eye

The following section describes one implementation of a model of displays and the human eye. After a description of an example display model, the remainder of this section focuses on a description of the anatomical and optical properties of the human eye, and an explanation of which are or are not included in this particular implementation (other implementations can include different properties, depending on the final application), and how they are simulated. Significant detail is given for the retinal cone synthesizer and the rasterization of individual photon events into individual photoreceptors within this synthesized retina. Because of the focus on color displays in this example, the eye model is a photopic model, and only simulates retinal cones; rods are not included (although they could be for other eye models).

### 1. Conventions and Units

Screen sizes are stated in units of centimeters (cm), all gross eye anatomical features are stated in units of millimeters (mm), fine anatomical detail are given in micrometers (microns) (μ), light wavelengths are expressed in nanometers (nm). The symbol θ will always express the angular eccentricity of a point on the retina (colatitude from the center of the fovea); note that the region of the retina up to an eccentricity θ covers an angular field of view of 2θ; note further that on the surface of the retina eccentricity θ corresponds to a slightly larger numeric angle of external light rays to the eye. Angles will be expressed in units of degrees (°), arc minutes, and arc seconds. Distances or areas on the surface of the retina expressed in units of mm or μ always assume a nominal 24 mm radius retina. Individual eyes are either left or right, but by using relative terminology (nasal, temporal) the eye is generally described independent of its side. In this description, a right eye is simulated, but this model can produce either right or left eyes. Pairs of simulated eyes are useful in understanding stereo effects.

### 2. Point Spread vs. Optical Transfer Functions

The optical transfer function (OTF) is a powerful technique for expressing the effects of optical systems in terms of Fourier series. The OTF works well (or at least needs fewer terms) when the details being modeled are also well described by Fourier series, as is the case for most analog and continuous inputs. But the sharp discontinuous sides and inter-pixel gaps that characterize both emissive pixels in modern displays and the polygonal cone optical apertures of the receptive pixels of the human eye do not fit this formalism well. So for some embodiments of the system, the mathematically equivalent point spread function (PSF) is used. Since the emission of each photon from a display surface pixel element is modeled as a discrete event, this is a fairly natural formulization. At the retinal surface of cones, the properly normalized PSF is treated as the probability density that the photon will appear at a given point.

Both formulizations apply only to light of a specific wavelength; the PSF of a broadband source of photons is the sum of the PSF at each wavelength within the broadband spectrum, weighted by the relative number of the photons at that wavelength. While resolution is often thought of as a grey scale phenomenon, many times chromatic aberration can be the limiting factor. Thus in some embodiments of the system all optical properties and optical effects are computed over many different spectral channels. Specifically, in one implementation all of the spectral functions cover the range from 390 to 830 nm; in inner loops, 45 channels at 10 nm increments are used, elsewhere 4401 0.1 nm channels are used.

### 3. Photon Counts of Displays

In deciding how to architect the simulation of the effects of display devices on the cones in the human eye, a natural starting point is to determine how many quanta events (photons) should be used.

Consider the example of a 2,000 lumen projector with a native pixel resolution of 1280·1024 @60 Hz, projected onto a (lambertian) screen 240 cm wide with a gain of 1, viewed from 240 cm away by a viewer with a 40 mm² entrance pupil. By definition, a lumen is a radiant flux of 4.09×10¹⁵ photons per second at an optical wavelength of 555.5 nm. In 1/60th of a second frame time, a single pixel of that display will emit 1.04×10¹¹ photons, spread over a 2π steradian hemisphere from the screen. At a viewer's 240 cm distance, this hemisphere is ˜36 meters in area, and a 40 mm² pupil will capture only 114,960 photons from that pixel. Only 21.5% of these photons will make it through all the tissue of the cornea, lens, macula, and into a cone to photoisomerize and cause a chemical cascade resulting in a change in the electrical charge of that cone, or about 24,716 perceived photons.

Not counting any optical aberrations, this single pixel will cover an angular region of 2.5·2.5 minutes of arc, or about 5·5 cones (in the fovea). Thus each cone will receive ˜ 1/25th of the photon count, or one pixel will generate 996 perceived photons per cone per 1/60 second. This calculation is for a full bright maximum value white pixel. Dimmer colored pixels will produce corresponding less photons.

While the more broadband emissions of a real projector will generate more (but less photo-effective) photons, the total number of quanta events at the cone level remains the same. This is a small enough number to model each individual quanta emission and absorption. With modern computing power, every photon that affects a portion of the retina for small numbers of display video frames can be modeled in a few hours of CPU time. In other implementations, fewer or more photons can be simulated.

### 4. Display Pixel Model

Unlike the Gaussian spots of CRT's (described in [Glassner 1995]), modern digital pixel displays employ relatively crisp, usually rectangular, light emitting regions. In direct view displays, each of the three (or more) color primaries have separate non-overlapping regions. In projection displays, the primaries generally overlap in space, though not in time for field sequential color display devices. At the screen, projection based displays have less crisp color primaries regions and more misalignment, due to distortions caused by optics, temperature, and manufacturing misalignment.

In one example, the system implements a general parameterized model of this sub-pixel structure. Each color primary also has its own spectral emission function.

The temporal structure of the sub-pixels varies wildly between different types of displays, and can have great effect on the eye's perception of the display. CRT displays (direct view or projected) have a fast primary intensity flash, which decays to less than 10% of peak within a few hundred microseconds. Direct view LCD devices have considerable lag in pixels settlings to new values, leading to ghosting, though this is beginning to improve. LCDs generally also use spatial and temporal dithering to make up the last few bits of grey scale. DLP™ projection devices are single bit intensity pixels dithered at extremely high temporal rates (60,000 Hz+); they also use several forms of spatial dithering. LCOS projection devices use true grey scale, and some are fast enough to use field sequential color.

All of these temporal and spatial features can be emulated for each different display simulated in various embodiments the system. The spectral properties also vary with display type. Direct view LCD and projection LCD, LCOS, and DLP™ devices effectively use fairly broadband color filters for each of their primaries. CRT green and blue phosphors resemble Gaussians, through red phosphors are notorious for narrow spectral spikes. (Appendix G4 of [Glassner 1995] shows an example of CRT spectra, as does FIG. 22.6 of [Poynton 2003].) Laser based displays by definition have narrow spectral envelopes.

### 5. Eye Geometry

This section further describes geometric and anatomical features of the human eye. The literature uses a number of potentially inexact terms, such as “visual axis”, as a definitional basis. The following section uses more exact geometrical definitions, but these preferably are related to the existing terminology. Thus first the existing terminology and some conventions used herein are presented. A section at the end describes an approach to scaling and individual variation.

i. Initial Approach to Coordinate Frames

Because the initial lens models are rotationally symmetric (and centered), the base defining coordinate frame of the eye is aligned to this optical axis. Retina geometry is rotated into this coordinate frame. The center of rotation of the eye is defined relative to this optical axis coordinate frame. The rotated fovea defines the visual axis that is used for the Listing's law orientation. Traced photons are rotated into the optical axis coordinate frame (by the transform defined by any eye rotations).

ii. Length (Size) of the Human Eye

Following the modern convention, the length of the eye is measured from the corneal apex (anterior pole) (front most part of the curved cornea outer surface) to the inside back of the eye (outer segments of retina (X-ray ring vanishes)), known as the posterior extent of the retina. Older measurements were calipers of the Outer Diameter of the eye. [Oyster 1999, p. 100.] Oyster further states that the size of a given eye is about the same, whether measured anterior to posterior, vertically, or horizontally (assumably also interior sizes).

The “nominal” length of the eye is the standard average value of 24 mm. The model supports other scaled sizes, in the full 20 mm to 30 mm range of (adult) human eye variation. ([Oyster 1999, p. 101], referring to [Stenstrom 1946].) Human eyes reach the near final size by approximately three years of age. However, schematic eye models use different lengths: [Atchison & Smith 2000, p. 171] gives a table showing radius (half-length) used; the equivalent lengths are 22.12 mm, 24 mm, 24.6 mm, 21.6 mm, and 28.2 mm. Since these are optical schematic models, rather than optical anatomical models, and not always wide field, it is not unreasonable that the radii differ from anatomical values.

One small definitional difference is that the modern convention implicitly defines the surface of the retina as the rear (furthermost from cornea) portion of the outer segment of the cones (due to X-ray ring vanishing). In implementations of the model, the surface of the retina is defined as the back ellipsoid portion (closest to outer segment) of the inner segments of the cones, where light that has passed the macula enters the fiber-optic like aperture of the cone inner segment. Thus the two definitions differ by some of the combined length of the cones inner and outer segments. The portion of the retina rear most from the front of the cornea will be several degrees from the fovea, so rather than a maximum of 50 nm length for the cone outer segment, a length of 50 nm for a combined length of both the inner and outer cone segments is more likely at this retinal location. On models where most features are measured only to an accuracy of one hundredth of a mm (10,000 nm), this extra 50 nm will make no effective difference. However, the real models have to make some assumption and stick to it; diffraction calculations will involve optical path length differences that must be correctly computed to a fraction of a nanometer.

iii. Center of Rotation of the Human Eye

The human eye center of rotation is not fixed; it shifts up or down or left or right by a few hundred microns over a ±20 degree rotation for straight ahead [Oyster 1999, pp. 103-104]. Others cite that the whole eye moves a little for similar size rotations.

The “standard” non-moving average center is given as a point on a horizontal plane through the eye, 13 mm behind the corneal apex (front most part of the curved cornea outer surface), and 0.5 mm nasal (toward the nose) to the line of sight [Oyster 1999, p. 104]. He gives a slightly simpler point as just 13.5 mm behind the corneal apex on the line of sight with no nasal offset. [Atchison & Smith 2000, p. 8] gives an average value of 15 mm behind the cornea (reference [Fry & Hill 1962]). There are individual variations that are apparently measurable. In some embodiments of the model, the (13, 0.5, 0.0) point is scaled relative to the “nominal” size eye and used as the center of rotation.

iv. Rotation of the Human Eye

The human eye has a full three degrees of freedom in its rotation, and can rotate torsionally by a fair amount (although usually to counteract opposite direction rotation due to head and body movements). However, for some types of movements, Listing's law holds to within a degree or so: rotations are confined to two degrees of freedom. The orientation of the Listing's plane that these two degrees of freedom holds for does appear to have some individual variation, and will change for different vergances and during pursuit motions. With the head unrotated, Listing's plane appears to be vertical, though slightly rotated to one side. For the early purposes of the model eye rotations will follow a simplified version of Listing's law:

Let the “line of sight” be a vector from the center of the fovea through the center of the pupil with the eye rotation is at “null” (e.g., a vector 5 degrees rotated horizontally from straight ahead, until the off-center pupil is considered). “Null” is optical axis straight forward. For any position of gaze away from this “null” rotation, the eye rotation should correspond to a rotation of the eye from null to the new position by the angle from the “line of sight” vector to the new gaze position vector (dot product of normalized vectors), rotated about a axis orthogonal to these two vectors (e.g., the axis defining the plane containing these two vectors). This rotation model is to hold for all points between two fixation points in a frame time; each micro-time rotation can be derived by applying this rule to the intermediate fixation point. The path of the fixations is specified separately; it can be a simple “great circle” path between the fixation points, or it can be a more complex elliptical curve, or even (see below) include a tremor function. Note that for a simple short eye rotation between two specified points, with both points obeying Listing's law, and thus specifying two quaterions, any linearly interpolated quaterion between these two will also lie on Listing's plane. Thus this method can be used for fast computation.

Note that what is being modeled here is not saccades between fixation points, but small drifts or smooth (pursuit or stabilizing) eye movements over several video frame times. In some implementations, the eye model is initially targeted at simulating what happens between saccades (e.g. seeing; about 1/10 of a second or so at a time).

v. Tremors, Drifts, and Microsaccades: Small Rotations of the Human Eye

There is no question that there is tremor in the rotational position of the eye (caused by the eye muscles). However, there is considerable difference in the literature as to its amplitude. Clearly some of the earlier estimates were far too large, but that does not mean that the opposite extreme of “it makes no difference” holds either.

[Oyster 1999, p. 134] has a diagram and some text for a “micronystagmus” (tremor). The high frequency tremor (approximated from the diagram, 50+ Hz) appears to be about one third of a minute of arc (about half a foveal cone on the diagram). Also shown is a low frequency drift; this appears to be about 3 minutes of arc per second ( 1/20=0.05 degrees per second).

[Steinman in Landy 1996] references [Ratliff and Riggs 1950] as saying that the high frequency tremor was less than one third of a minute of arc and had a frequency of 30 to 80 Hz, and concluded that “this is small enough to have no effect on vision”. Other recent references have larger amplitudes.

It looks like the low frequency drift is more important than tremor; however the model can take an experimentalist view, and simulate eye movements both with and without tremor of a specified amplitude.

[Engbert & Kliegl 2004] defines drift as “a low velocity movement with a peak velocity below 30 minutes of arc per second” without giving a source for the definition. This half a degree per second is fairly fast, and at a density of two cones per minute of arc, corresponds to a blur of one cone per 1/60 of a second frame rate. (Cone integration time is both slower and faster than this.) A mean speed figure of 24.6 degrees per second is given in [Martinez-Conde et al. 2004] from a 1983 reference, from a 1967 reference a maximum speed of 30 minutes per second and a mean speed of 6 minutes per second is given. The later (6 min/sec) is ⅕ the max rate, and would correspond to traversing ⅕ of a cone per 1/60th of a second frame rate, or 1/2.5 of a cone in 1/30th of a second. All of these different drift rates can be and many have been simulated in various embodiments of the system, and their effect empirically measured.

vi. Center of the Pupil of the Human Eye

The center of the physical pupil is offset from other elements of the eye (presumably the cornea). The amount of variation is individual, but the “typical” value is given as 0.5 mm nasal (toward the nose) [Oyster 1999, pp. 107, 421]; [Atchison & Smith 2000, p. 23]. [Atchison & Smith 2000] experiments with 1 mm de-centering. Empirical testing has shown that 0.25 is a good default value for some embodiments of the model.

The dilation of the physical pupil does not expand about (this) single center point. Again, there is individual variation. The movement is temporal, and “up to” 0.4 mm [Atchison & Smith 2000, p. 23], [Walsh 1988], [Wilson et al. 1992], 1 degree [Wyatt 1995].

In some embodiments, the model does not include a tilt of the iris (which defines the physical pupil). [Thibos, De Valois 2000, p. 32] has the visual axis (centered on the fovea) aligned with the pupil axis; this is one possible measure of tilt (since the fovea is several degrees off the optical axis) that can be included in some embodiments of the model.

The iris, and thus the physical pupil, has finite thickness (˜0.5 mm), this also effects diffraction. The thickness is less than half this at the pupillary ruff, but broadens at a high angle (30 degrees plus). It has been noted that this non-infinitesimal thickness can have an effect [Atchison & Smith 2000, p. 26].

The slight raggedness of the iris edge is not modeled in some embodiments of the system. The physical pupil position relative to the lens usually has the plane of the pupil coincident with the front most portion of the lens, but the curved shape of the pupillary ruff probably puts the pupil 0.25 mm or so in front of the lens (plus the next 0.25 to 0.5 mm for the thickness of the iris), but as the lens changes in thickness this can change, and the front most portion of the lens will approach the rear plane of the pupil, and likely pass through.

Note also that when the lens accommodates (changes thickness) it primarily moves forward, and moves the physical pupil forward with it. (Many eye models do include this effect.) The amount of axial distance change is on the order of 0.4 mm [Atchison & Smith 2000, p. 22]. One embodiment of the model includes this effect. Automatically moving the pupil when the lens shape changes moves the front location of the lens.

vii. Size of the Pupil of the Human Eye

The human eye pupil can vary in diameter from 2 mm to 8 mm in young adults (presumably relative to the nominal 24 mm eye length) [Oyster 1999, p. 413]; [Atchison & Smith 2000, p. 23]. While the pupil is generally assumed to be circular or elliptical, [Wyatt 1995] indicates that the shape is more complicated. Real pupils are not only slightly elliptical in shape (˜6%), but have further irregular structure [Wyatt 1995]. The pupil is also not infinitely thin; high incident angle rays will see an even more elliptically shaped pupil due to its finite thickness (˜0.5 mm). In building the system these additional pupil shape details were considered. However, at the density that the system samples rays through the pupil, none of these details other than the decentering make a significant difference in the computation results, so in some embodiments, they are not model parameters. [Wyatt 1995] comes to a similar conclusion.

Most references to pupil size in the human eye are in terms of the apparent size of the pupil as viewed from outside the eye through the cornea: the virtual entrance pupil. The actual anatomical physical pupil size (as simulated) is 1.13 time smaller. The size and position of the pupil that the cones see through the lens changes again: the virtual exit pupil. The relative direction to the center of the virtual exit pupil from a given point on the surface of the retina is an important value; this is the maximal local light direction that the cones point in, and is involved in the Stiles-Crawford Effect I below.

An entrance pupil size of 2 mm corresponds to an area of 3.1 mm2; a 4 mm entrance pupil to an area of 12.6 mm²; an 8 mm entrance pupil to an area of 50.3 mm². An entrance pupil with an area specified as 40 mm2 corresponds to a diameter of 7.1 mm.

Because of the exact ray tracing involved, internally the system should model the physical pupil (in size, position, related shifts therein, and tilt, if any). However input conversion can be performed when a user want to express entrance pupil sizes.

Repeating, the system models the exact physical size of the hole in the iris as the pupil. The size and positions of the virtual entrance and exit pupils are approximated only for input and output conversion purposes. During actual ray tracing, the edges and centers of the virtual entrance and exit pupils are empirically computed from the physical pupil and the effects of the modeled optical elements.

There is a known formula for predicting pupil size relative to illumination level, and changes in illumination level. This formula is only an average model; it certainly does not take into account physiological components (startlement, for example). However, because the illumination level generally is derivable from the other inputs of the eye model, and option to have the pupil size computed, rather than taken as an input variable, can be added. To minimize optical aberrations, a slightly smaller pupil size is used than these formulas would predict for the illumination levels of the video display devices being simulated, in some embodiments.

viii. Center and Orientation of the Crystalline Lens of the Human Eye

The lens of the human eye can be tilted or skewed with respect to the pupil [Oyster 1999, p. 107, but the amounts are not quantified, except indirectly in terms of its optical axis. One embodiment of the model supports a relative rotation and offset of the lens, but the default is none. Some new papers indicate that machines are being built to empirically measure the tilt of the lens, but they do not give any data on the amounts of tilt (or the direction of tilt) discovered.

ix. Position of the Fovea of the Human Eye

The fovea is centered at a point inclined about 5 degrees temporal (away from the nose) on a horizontal plane from the “best fit” optical axis of the eye [Atchison & Smith 2000, p. 6]. Because of the inverting optics of the eye, the fovea is looking at a spot ˜5 degrees nasal (toward the nose) from the “straight ahead” optical axis of the eye. Because the optics of the eye start to degrade well less than 5 degrees from their center, one implementation of the model uses this 5 degree position of the fovea.

x. Position and Size of the Optic Disc and Blind Spot of the Human Eye

The optic disc is approximately 5 degrees wide and 7 degrees tall. The center of the optic disc is approximately 15 degrees nasal (towards the nose) and 1.5 degrees upward relative to the location of the fovea. This is on the surface of the retina; visually the spot is temporal and downward. [Atchison & Smith 2000, p. 7.]

xi. Position, Size, and Density of the Macula Lutea of the Human Eye

The macula is a disk of yellowish pigment centered on the fovea. The thickness of the macula diminishes with distance from the fovea. The function of the macula is thought to be to greatly reduce the amount of short wavelength light (blue through ultraviolet) that reaches the central retina that has not already been absorbed by the cornea and lens, and thus a simulate of it is included in some embodiments of the system.

In one implementation, the data set [Stockman and Sharpe 2004] is used. The effect is strongest at the center of the fovea, and falls off approximately linearly to zero at its edge. The macula can be geometrically characterized as a radial density distribution centered on the fovea. However, the extent of the macula, as well as the peak thickness, is subject to individual variation. In general the radial extent is about 10 degrees. ([Rodieck 1998, p. 126]: retinal eccentricity 9 degrees, 2.5 mm; diameter 18 degrees, 5 mm. [Oyster 1999, p. 662]: diameter of 2 mm. [Atchison & Smith 2000, p. 7]: diameter 5.5 mm, 19 degrees.) Some of the same pigment that makes up the macula is found throughout the rest of the retina. How the thickness of the macula varies, or even if it does, does not seem well documented. The absorbance spectra of the macula are described in the spectra section.

xii. Head Notes

During walking and running, the head can oscillate up and down up to 2.7 Hz. Natural neck turns can have rotatory accelerations up to 3K degrees per sec², and velocities up to 400 degrees per second [Thurtell et al. 1999].

xiii. General Scaling Rule vs. Other Individual Differences

One implementation of the model is meant to be a fully parameterized model in all relevant anatomical features. There is a question of how these individual parameters should be set. Because the human eye system physically scales, one possibility would be to set all parameters relative to a nominal scale eye, and then also specify an overall scale parameter. But this would be awkward when absolute feature size data is available for an eye of non nominal size. Further it leads to possible ambiguities; suppose one wants to move the cornea a little forward in an otherwise nominal eye. The scale parameter model would require all the other parameters to be changed down in size (relative to the nominal model), and then the entire model to be scaled up to reflect the new corneal to retina length.

Thus the direction chosen is to support a mixed relative/absolute scale parameterization. Care has to be taken when setting these parameters to not mix scales unintentionally.

First, the retina is modeled by a separate batch process. This retinal generation supports the parameterization of a single radius for the spherical retina. All features of the retina (cone size and variation of size with eccentricity) can be specified either in relative terms (relative to a nominal 12 mm radius retina), or in absolute values (independent to the specified retina size). There is a further element of scale; when a generated retina is loaded into the complete eye model, there is the option to scale it again, to fit any specified radius (the radius at the time of generation is known and kept in the generated file). This allows the same generated retina to be used with different absolute scale eyes; indeed if all the retinal features during retinal generation had been specified as relative to scale, this additional scale would be no different than generating different absolute size retinas. In summary, the absolute size of the retina is specified as a parameterization of the complete eye model, regardless of the retinal size specified when a particular retina was generated. If complete control is desired, the same retinal size should be specified to both the retina generation program and to the complete eye model program.

Parameters of the complete eye model can also be specified in either absolute or relative terms. The fundamental scale of the complete eye model is controlled by the size of the retina; all relative anatomical sizes and positions are relative to a nominal 24 mm diameter retina.

The coordinate system of the retinal generation program has the origin on the surface of the fovea, at the center of the fovea. The horizontal and vertical axis are the x and y axis, respectively, and the z axis is negative coming from the surface of the retina towards the center of the retinal sphere.

When retinas are read into the complete eye system, the x and z axis are flipped, and the center moved to the center of the (given size) retinal sphere. The retina is then rotated five degrees temporal (away from the nose) to place the fovea center relative to the optical axis defined by the cornea. This scaled, offset, and rotated retina is then re-centered to the eye system coordinates center. For example, −0.0797 mm different in x than the retinal sphere center can be used. When the eye is rotated under movement, a separate center as specified above is used in this example. In other examples, the centers used may be further unified.

### 6. Schematic Eyes

Schematic eyes [Atchison and Smith 2000] are simplified optical models of the human eye. Paraxial schematic eyes are primarily for use within the paraxial region where sin[x]≈x, e.g. within 1° of the optical axis. In many cases the goal is to model only certain simple optical properties, and thus in a reduced or simplified schematic eye the shape, position, and number of optical surfaces are anatomically incorrect.

Having optical accuracy only within a 1° field can be a problem for an anatomically accurate eye, as the fovea (highest resolution portion of the retina) is located 5° off the optical axis. Finite or wide angle schematic eyes are more detailed models that are accurate across wider fields of view.

### 7. Variance of Real Eyes

Even finite schematic eyes generally come in one size and with one fixed set of optical element shapes. The idea is to have a single fixed mathematical model that represents an “average” human eye. However, real human eyes not only come in a range of sizes (a Gaussian distribution with a standard deviation of ±1 mm about 24 mm), but many other anatomical features (such as the center of the pupil) vary in complementary ways with other anatomical features such that they cannot be simply averaged. Because a goal for this example is to simulate the interaction of light with fine anatomical details of the eye, a parameterized eye is constructed, in which many anatomical features are not fixed, but parameters. Which features are parameters will be discussed in later sections.

### 8. Photon Count at Cones

Schematic eyes are generally not used to produce images, but to allow various optical properties, such as quantified image aberrations, to be measured. In a few cases the image formed on the surface of the retina may be created [Barsky 2004]. But this image is not what the eye sees, because it has not taken into account the interaction of light with the photoreceptor cones, nor the discrete sampling by the cone array.

The human retinal cones generally form a triangular lattice of hexagonal elements, with irregular perturbations and breaks. Sampling theory in computer graphics [Cook 1986; Cook et al. 1987; Dobkin et al. 1996] has demonstrated the advantages of perturbed regular sampling over regular sampling in image formation. The specific sampling pattern of the eye is modeled in various embodiments of the system. Thus a retina synthesizer was constructed; a program that would produce an anatomically correct model of the position, size, shape, orientation, and type distribution (L M S) of each of the five million photoreceptor cones in the human retina.

### 9. Eye Rotation During Viewing

Even while running and looking at another moving object, the visual and vestibular systems coordinate head and eye movements to attempt to stabilize the retinal image of the target. Errors in this stabilization of up to 2° per second slip are not consciously perceivable, though measurements of visual acuity show some degradation at such high angular slips [Rodieck 1998; Steinman 1996].

At the opposite extreme, for fixation a non-moving object (such as a still image on a display device), three types of small eye motions remain: tremor (physiological nystagmus), drifts, and microsaccades [Martinez-Conde et al. 2004]. Microsaccades are brief (˜25 ms) jerks in eye orientation (10 minutes to a degree of arc) to re-stimulate or re-center the target. Drifts are brief (0.2 to 1 second) slow changes in orientation (6 minutes to half a degree of arc per second) whose purpose may be to ensure that edges of the target move over different cones. Tremors are 30 to 100 Hz oscillations of the eye with an amplitude of 0.3 to 0.5 minutes of arc. These small orientation changes are important in the simulation of the eye's perception of display devices, because so many of them now use some form of temporal dithering. There is also evidence that orientation changes are important to how the visual system detects edges.

One implementation of the system allows a unique orientation of the eye to be set for each photon being simulated, in order to support motion blur [Cook 1986]. While the orientation of the eye could be set to a complex combination of tremor, drifts, and microsaccades as a function of time, because there is some evidence that cone photon integration is suppressed during saccades, in one example, a single drift between microsaccades as the orientation function of time is simulated. Assuming that drifts follow Listing's law; the drift is a linear interpolation of the quarternions representing the orientation of the eye relative to Listing's plane at beginning and end of the drift. In one example, the default drift is 6 minutes of arc per second at a 30° to the right and up. The neutral vergence Listing's plane is vertical and slightly towed in corresponding to the 5° off-center fovea.

The rotational center of the eye is generally given as 13.5 mm behind the corneal apex, and 0.5 mm nasal [Oyster 1999]. One implementation of the model uses this value. In one embodiment, the few hundred microns shift in this location reported for large (±20°) rotations is not simulated, but in other embodiments it can be.

### 10. The Optical Surface Model

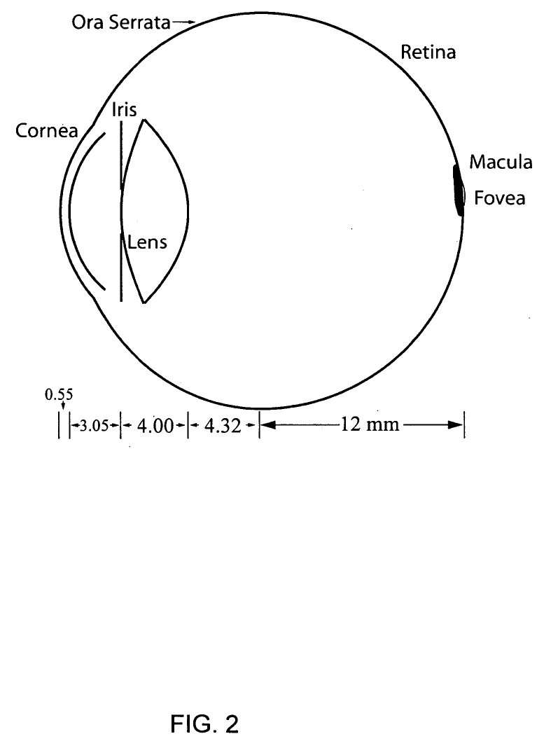

Most of the traditional finite schematic eye models were too anatomically inaccurate for use with the system of the present invention. An anatomically correct and accurate image forming simple model is [Escudero-Sanz 1999]. It is a four optical surface model using conic surfaces for the front surface of the cornea (conic constant −0.26, radius 7.72 mm) and both surfaces of the lens (conic constants −3.1316 and −1.0, radii 10.2 and −6.0 mm respectively), and using portions of a sphere for the back surface of the cornea (radius 6.5 mm). In addition, the pupil is modeled as an aperture in a plane, and the front surface of the retina (radius 12.0 mm) is modeled as a sphere. The optics and pupil are assumed centered. Indices of refraction of the mediums vary as a four point polyline of optical wavelength. Escudero-Sanz model was used as a starting point for the optical elements of the system. One modification to the Escudero-Sanz model when focusing on a fovea 5° off the corneal optical axis was to decenter the pupil by 0.25 mm, which is consistent with decenter measurements on real eyes. Another modification is to the parameters of the front surface of the lens and the position of the pupil to model accommodation to different depths and different wavelengths of light. The modified version of the Escudero-Sanz schematic eye is shown in FIG. 2. All dimensions in FIG. 2 are given in millimeters.

While it has been known for over a hundred years that the human eye lens employes a variable index of refraction, until recently there has been very little empirical data on how the index varies, and the recent data is still tentative [Smith 2003]. Nevertheless, in a search for anatomical accuracy, simulations were made of a number of published models of variable index lenses [Atchison and Smith 2000], including that of [Liou and Brennan 1997], whose schematic eye did include a decentered pupil. When layered shells of constant refractive index are used, modeling the lens using less than 400 shells usually produces too many quantization effects. Even with this many shells, the models generally did not produce acceptable levels of focus (to be fair, most did not claim high focus accuracy). Most of the models let the index of refraction vary as a quadric function of position within the lens; an analysis of the focus errors showed that this may be too simple to model the lens well. Because the primary emphasis of some embodiments of the system of the present invention is the retina and its interaction with diffracted light, a simple non-variable index conic surface lens model was selected, as shown in FIG. 2.

New measurement devices mean that more accurate data on the exact shape of the front surface of the cornea is now available [Halstead et al. 1996]; this has been used to simulate retinal image formation by particular measured corneas [Barsky 2004]. However there are accuracy issues in the critical central section of a normal cornea. So while one goal of some embodiments of the system was to create a framework where more anatomical elements can be inserted into the parameterized eye as needed, for the front surface of the cornea, a conic model was selected, as shown in FIG. 2.

### 11. The Human Retina & Photoreceptor Topography

This section further describes many of the specifics of the retina of the human eye. In regards to the retina, the literature defines a number of terms, but unfortunately the definitions and usages are not consistent. Thus first the existing terminology and some conventions are presented. The term retina refers to the interior surface of the eye, containing the photoreceptors and associated neural processing circuitry. Thus geometrically the retina is a sub-portion of a sphere: a sphere with a large hole in it where the retina starts at the ora serrata (see FIG. 2).

Positions on the retina are measured in several ways. The most common are variations of eccentricity: the colatitude, a measure of the distance from a center point on the retina (usually, but not always, the fovia), either as an angle or a distance along the curved surface. There are several ambiguities possible in what angle is meant. Many times the most interesting angle is the visual angle. So for example, “10 degree from the fovea” means a point on the retina that would be illuminated by an external point of light that subtends a (visual) angle of ten degrees with an external point of light that would illuminate the center of the fovea. This is different from, but very similar to, the angular measurement with a center on the spherical center of the retina of a point on the retina relative to the point of the center of the fovea on the retina. This is confounded because the retina is not truly a sphere, and there are multiple possible choices of compromise approximate sphere centers. Several conversions will be given later. As an internal angle, the retina extends to more than ±90 degrees from the fovea (e.g., the retina covers more of a sphere than a hemisphere). The maximal extent of the retina in eccentricity varies with orientation; it is not the same in all directions.

A retinal eccentricity given as a distance clearly refers to internal retinal measurements; the radial distance of a point from the center of the fovea along the curved surface. These distances are usually given in mm or um. The potential problem here is that the (internal) diameter of the specific eye for which the measurement was made. In some cases, it is unclear if the difference is the real physical distance on a specific eye (which will invariably have an internal diameter different than the “standard” 24 mm), or if the distance has been “corrected” to an equlivant distance on a 24 mm eye.

Given that the eye model is an exact internal model of the eye, many angular measurements need to be given in terms of an internal angle from the fovia, centered on the retinal sphere. The fovia is generally defined as a depressed circular portion of the retina 5 degrees of visual angle in extent centered on the, (recursively used) fovia center. In linear (radial) measurement, this is 1500 um, with 300 um defined as the equlivant to 1 degree of visual angle. (The 5 degrees is from [Polyak 1941].) The foveola is the vascular (blood vessel) free center of the fovea has a diameter of approximately one half of a degree of visual angle. The macula is an approximately 2 mm diameter circle region centered on the fovea. The flat bottom of the foveal pit has a diameter of approximately one degree of visual angle (300 um), and corresponds to the rod-free portion of the fovea. (This is a radius of 150 um, ˜0.5 degree.)

Most real retinas are actually slightly ellipsoidal; if the length of the eye does not match the refractive power of the eye, the result is myopia or hyperopia; inequality in width to height can produce astigmatism. The actual shape deviates further from a sphere as you look at fine details: flattening both near the optic nerve and the cornea, and deepening at the foveal pit. The simulation can be extended to these cases, but in some examples, a perfectly spherical model is used.

The human retina contains two types of photoreceptors: approximately 5 million cones and 80 million rods. The center of the retina is a rod-free area where the cones are very tightly packed out to a visual angle of 0.5° of eccentricity. After this point, rods start appearing between the cones. [Curcio et al. 1990] is one work describing the variation in density of the cones from the crowded center to the far periphery, where it turns out that the density is not just a fuiction of eccentricity, it is also a function of orientation. There is a slightly higher cone density toward the horizontal meridian, and also to the nasal side.

i. Distribution of Cones in the Retina

The distribution of the three different cone types (L, M, and S, for long, medium, and short wavelength, roughly corresponding to peak sensitivity to red, green, and blue light) is further analyzed by [Roorda et al. 2001]. The L and M cone types vary completely randomly, but the less frequent S cone type tends to stay well away from other S cones. There are a range of estimates of the ratios of S to M to L cones in the literature, and there certainly is individual variation. For some embodiments of the system this is an input parameter; and 0.08 to 0.3 to 0.62 is used as a default. Out to 0.175° of eccentricity in the fovea there are no S cones; outside that their percentage rapidly rises to their normal amount by 1.5° eccentricity.

At the center of the fovea, the peak density of cones (measured in cones/mm²) varies wildly between individuals; [Curcio et al. 1990] reports a range of values from 98,200 to 324,100 cones/mm² for different eyes. Outside the fovea, there is much less variance in cone density. [Tyler 1997] argues that the density of cones as a function of eccentricity outside the central 1° is just enough to keep the photon flux per cone constant, given that cones at higher eccentricities receive less light due to the smaller exit pupil they see, as well as the larger amount of not completely transparent cornea and lens tissue the light has to traverse in order to reach a peripheral cone. Tyler's model for density from 1° to 20° of eccentricity θ is:

$$\frac{cones}{{mm}^{2}} [ θ ] = 50000 \cdot {( \frac{θ}{300} )}^{- 2 / 3}$$

This model is used in some implementations of the system, modulated by the cone density variations due to orientation from [Curcio et al. 1990]. Beyond 20° of eccentricity, Tyler's suggested linear fall-off to 4,000 cones/mm² at the ora serrata is followed.

At 2.65 mm from the retina, in both the nasal and temporal directions, the cone density is about the same at 10K cones/mm². But the density drop to 7K cones/mm² occurs 33% further from the fovial center in the nasal (5.3 mm) than the temporal (4.0 mm). The nasal/temporal ratio (N/T ratio) at the ecentricity of the optical disk (4 mm nasil) is 1.25, and increases to 1.40-1.45 at 9 mm distance from the center of the fovia and beyond. This means that there is 40% to 45% more cones/mm² in most portions of the perphical nasal retinal retina than the same ecentricities of the temporal retina.

The cone density stops changing much towards the far periphery (to a range of 5K to 6K cones/mm²) (and goes up a little at the far edge). The total density change is 47× between the center of the fovia and 9 mm ecentricity from the retina, and goes down another 20% between 9 mm and 18 mm. Curcio points out that the optical magnification changes between the fovia and the periphery; the optical model he uses changes the 47× to 53× at the 9 mm point (32 degrees optically), and the 20% additional density change between 9 mm (32 deg) and 18 (68 deg) mm becomes a 49% change in equivalent density (per steradian rather than mm²). For some embodiments of the eye model, the optical power change is whatever the optical power change is, so it is the cone density per mm² that is modeled. As discussed elsewhere, at large eccentricity, the cone shapes cross-sectioned at the plane of the retinal surface (spherical or otherwise) become elliptical because of the cones orientating in the direction of the exit pupil.

Thus for the model, while any cone density distribution can be modeled, the “standard” model has a few parameters. One is the peak density of cones/mm². In one software implementation of the model, empirically the peak density is targeted a little lower in size that the actual density desired in the central foveal region; this is likely due to the central cone migration packing pressure. Specifically, in order to achieve a desired density of 150,000 cones per mm², a target of 125,000 cones per mm² was set. Outside the central fovea, the emperically generated cone desnity much more closely tracked the input target density. The general density function is a function of eccentricity and direction. One possible model is a piecewise linear model based only on eccentricity and several eccentricity/density data points, another was similar but had data points with coordinates of direction as well as density.

Another model is a sequence of four piecewise ellipse quadrants of constant cone density. Density variation at eccentricities between ellipse entries interpolated by a normalized version of the −⅔ power rule for eccentricities between 300 nm and 20*300 nm, a lower lessining after 200*300 nm, and a constant density within the peak area (parameterizable, 10 to 30 nm radius). Between the peak area and 150 nn, something similar to the −⅔ power rule is used, but auto parameterized to match from the peak value at the peak outer eccentricity to the 50K cones/mm² at the 300 nm eccentricity. The “normalization” of the −⅔ power rule beyond 300 nm are for the four ellipse segments to match the (nasel, down, temoral, up) relitive ratio values for constant cone/mm² density. Thus a handful of parameters allow cone density functions to be generated that match any of the Curcio data and beyond. In one embodiment, the default parameters will come close to matching the “averaged” Curcio data.

ii. The Variation of Size of Cones in the Retina

Up to the edge of the rod free zone (150 nm radius), the size of the cones (except for the S (blue)) is given by the simple inverse of the cones/mm² density. In the periphery, the cones grow in size to 5-9 um, and still account for ˜⅓ of the receptor surface area (the rest is rods). So above some eccentricity (20*300 nm), the area of the cones is one third the area given by the simple inverse of the cones/mM² density. Between 150 nm and 20*300 nm, the percentage of the area taken by the cones should drop from 1 to ⅓, by some approprate function.

As discussed in the next two sections, the area of the cones beyond the fovia is reduced even further from the values discussed above if the cone area is to be measured as a cross section of the cones in the local plane of the retina (spherical or otherwise), due to the tilt in orientation of the cones.

iii. The Distribution of Orientations of Cones in the Retina

Cones in the retina do not point at the center of the retinal sphere. That is, they do not point directly out (normal to) the surface of the retina. Instead, the cones point in the direction of the exit pupil of the eye, within about 1 degree of variation. Note though that the exit pupil is much more than a degree in size from the point of view of the cones, and that in some individuals the orientations cluster about a direction that while within the exit pupil, is considerably off-center [Roorda and Williams 2002].

Because the exit pupil is located more towards the front of the eye, this means that cones of greater eccentricity will point at greater angles to the spherical retinal surface normal. In turn this means that the apparent shape of the cones when viewed normal to the retinal surface will change from circular (polygonal) to more ellipsoidal, as described in the next section.

iv. The Variation of Shape of Cones in the Retina

If the external limiting membrane of a cone's inner segment is viewed as the planer surface of photon capture for a cone, then technically this can be modeled as a plane tilted with respect to the local spherical retinal slope, because the cones point at the exit pupil of the eye, not directly out from the retinal surface (see previous section). The inner limiting membrane of the inner segment is the first layer light reaches on its way into the inner segment, and then the photo pigment filled outer segment.

Because the eye model is fully three dimensional, the cone photon capture aperture could just be a polygon properly tilted with respect to the local retinal plane. However, the same processing results can be obtained by modeling the capture region as flat in the local retinal plane, but ellipsoidal in shape, so long as the normal used for the SCE-I effect is still properly tilted. The degree of variance from circular shape is determined by the cosine of the difference between the angels: the local retinal surface normal (spherical or more general), and the orientation direction of the cone (towards the center of the exit pupil).

### 12. What Does a Cone Look Like?

Before describing this implementation of a retina synthesizer, some additional three dimensional information about the shape of the optically relevant portions of photoreceptor cones is relevant. In the fovea, the cone cell's terminal and axon are pulled away from the optically active inner and outer segment of the cone. All other retinal processing cells are also pushed to the side of the retina.

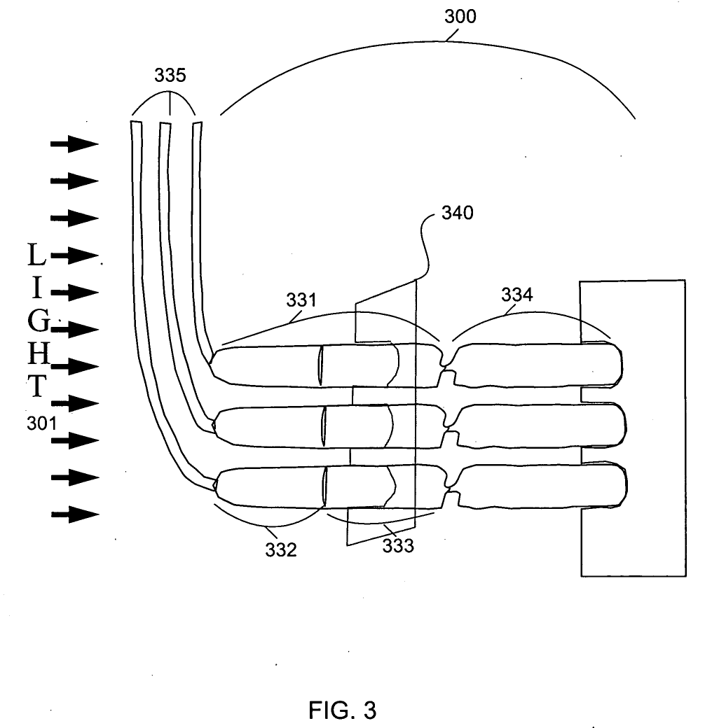

FIG. 3 shows three neighboring cone cells 300. Each cone cell 300 has an inner segment 331 made up of a myoid portion 332 and an ellipsoid 333 portion, and an outer segment 334. Each cone cell is connected to the nucleus by fibers 335. Incoming light 301 first hits the inner segment 331, which due to its variable optical index acts like a fiber optics pipe to capture and guide light into the outer segment 334. The outer segment 334 contains the photoreceptor molecules whose capture of a photon leads to the perception of light. In the fovea, these portions of the cone cells 330 are packed tightly together, and the combined length of the inner 331 and outer segment 334 is on the order of 50 microns, while the width of the inter segment 331 may be less than 2 microns across. A section through the ellipsoid portion 333 of the inner 331 segment, shown as plane 340 in FIG. 3, is the optical aperture that is seen in photomicrographs of retinal cones, and is the element simulated by the retina synthesizer. Outside the fovea, the cone cells 300 are more loosely packed, shorter (20 microns), wider (5-10 microns), and interspersed with rod cells. In addition, the rest of the cone cell 300 and all of the other (mostly transparent) retinal processing cells and blood supply lie on top of the cones and rods. Photomicrographs of foveal cones may not always have their limited depth of field focused precisely on the ellipsoid portion 333 of the inner segments 331; S cones look either larger or smaller than L and M cones depending on focus depth. Optically, another diffraction takes place at the entrance aperture of the cone inner segment 331; thus especially in the fovea where the separation between the active areas of cones are less than the wavelength of light, it is not entirely clear where within the first few microns of depth of the inner segment 331 the aperture actually forms. In some embodiments of the system, the polygonal cell boarders as created are used.

### 13. The Retina Synthesizer

In one implementation of the retina synthesizer, given parameterized statistics of a retina, as described in the previous sections, it “grows” a population of several million packed tiled cones on the inside of a spherical retina. The description of each cone as a polygonal aperture for light capture is passed on as data for later stages of the system. The rest of this section will describe how the retina synthesizer works.

A retina is started with a seed of seven cones: a hexagon of six cones around the center-most cone. The retina is then built by several thousand successive growth cycles in which a new ring of cones is placed in a circle just outside the boundary of the current retina, and then allowed to migrate inward and merge in with the exiting cones. Each new cone is created with an individual “nominal” target radius: the anatomical radius predicted for the location within the retina at which the cone is created.

Each cone is modeled as a center point, and during each growth cycle these points are subject to two simulated forces: a drive for each cone to move in the direction of the center of the retina; and a repulsive force pushing cone centers away from each other. This intra-cone repulsive force comes into effect when the distance between a pair of cones becomes less than the sum of their two nominal radii, and is stronger at closer distances. The center driving force includes a random component, and its overall strength diminishes as a growth cycle progresses (effectively simulated annealing) through between 25 to 41 sub-cycles.

Each of these sub-cycles consists of two parts: computing and applying the forces, and (re-)forming cone cell boarders. The forming of cell boarders is a topological and connectivity process that is similar to constructing Vornonoi cells, but with additional cell size constraints. In general, two or more cones might share a cell boarder edge vertex if pair-wise all of their centers are no further apart than 1.5 times the sum of their nominal radii. There are exceptions in complex cases: five cones need to share a pair of cell boarder edge vertices, but two of the five cones only “see” a four cone share group, and have to go with the maximum that their neighbors see, not just what they see. Because cone cell boarders are constrained to be convex polygons of a maximum size, in some cases a cell boarder will belong only to one cone, with a void on the other side. These are explicitly represented, and appear to occur in real human retinas as well.

The number of relaxation sub-cycles used has an effect on the regularity of the resulting pattern. A large number of cycles, for example, 80 cycles, is enough for great swaths of cones to arrange themselves into completely regular hexagonal tiles, with major fault boarders only occasionally. A small number of cycles, for example, 20 cycles does not allow enough time for the cones to get very organized, and the hexagonal pattern is broken quite frequently. In one embodiment, the “just right” number of cycles, 41 cycles in this example, produced a mixture of regular regions with breaks at about the same scale as imagery from real retinas. After setting this parameter empirically, it was discovered that real central retinal patterns have been characterized by the average number of neighbors that each cone cell has—about 6.25. The simulated retinas have the same number of average neighbors with the parameterization; different parameterizations generate different average neighbor counts. In one implementation, the number of sub-cycles was dropped outside the fovea to simulate the less hexagonally regular patterns that occur once rod cells start appearing between cone cells in the periphery. In this embodiment, the retina synthesizer does not simulate rods explicitly, but it does reduce the optical aperture of cones (as opposed to their separation radii) in the periphery to simulate the presence of rods.

The algorithm as described does not always produce complete tilings of the retina, even discounting small voids. Sometimes a bunch of cones will all try to crowd through the same gap in the existing retina edge, generating enough repulsive force to keep any of them from filling the gap; the result is a void larger than a single cone. Other times a crowd of cones will push two cones far too close together, resulting in two degenerate cones next to each other. Such faults are endemic to this class of discrete dynamic simulators, and while a magic “correct” set of strength curves for forces might allow such cases to never occur, it is more expedient to seed new cones in large voids, and delete one of any degenerate pair. In experiments, retinas have been grown as large as 2.7 million cones (more than half way to the 5 million full retina count) with very few voids larger than a cone. In another embodiment, retinas are grown as large as 5.2 million cones with very few voids larger than a cone.

It is not practical to dynamically simulate forces on such a large number of cones simultaneously. Instead, cones are marked by their path length (number of cone hops) to the currently growing edge. Cones deep enough are first “frozen”: capable of exerting repulsive force, and changing their cell boarders, but no longer capable of moving their centers; and then “deep frozen”: when even their cell boarders are fixed, and their only active roll is to share these boarders with frozen cells. Once a cone only has deep frozen cones as neighbors, it no longer participates in the growth cycle, and it can be output to a file, and its in-core representation can be deleted and space reclaimed. The result is a fairly shallow (˜10 deep) ring of live cones expanding from the central start point. Thus the algorithm's space requirement is proportional to the square root of the number of cones being produced. Still, in one embodiment, the program takes about an hour of computation for every 100,000 cones generated, and unlike other stages of the system, cannot be broken up and executed in parallel. However, once generated, a retina can be reused multiple times.

The optical disc (where the optic nerve exits the eye) is modeled in the system as a post process that deletes cones in its region: 15° nasal and 1.5° up from the foveal center, an ellipse 5° wide and 7° tall.

Each cone is modeled individually, and the initial target cone radius is just used to parameterize the forces generated by and on the cone. The final radius and polygonal shape of each cone is unique (though statistically related to the target), and even in areas where the cone tiling is completely hexagonal the individual cones are not perfect equal edge length hexagons, but for example, slightly squashed and lining up on curved rows. It is these non-perfect optical apertures that is the desired input to the later stage of rasterizing diffracted defocused motion blurred photons.

The resulting patterns are similar to photomicrographs of real retinas. For examples of simulated retinas compared to images of living retinas, see FIGS. 1, and 5-8 of U.S. Provisional Patent Application Ser. No. 60/647,494, “Photon-based Modeling of the Human Eye and Visual Perception,” filed Jan. 26, 2005, which has been incorporated herein by reference.

While the algorithm is not intended to be an exact model of the biology of retinal cone cell growth, it does share many features with the known processes of human retinal cone formation, where foveal cones are still migrating towards the center of the retina several years after birth.

The retinal synthesizer has all the connectivity information it needs to generate receptor fields of cones, and it does so. Small receptor fields are created using a single cone as the receptor field center, and all of that cone's immediate neighbors (ones that it shares cell edge boundaries with) as the suround. Larger receptor fields are created by using a cone, and one or more recursive generations of immediate neighbors as the center, and then two or more recursive generations of immediate neighbors outside the center as the surround. Separate algorithms are used to set the relative strength of the center and its antagonistic surround, and do perform the processing of inputs to these receptor fields. The results of this processing also generate images, this time of retinal receptor fields; the values are passed onto the parts of the simulator that emulates the LGN and beyond.

### 14. Cornea and Lens Density

While the cornea and lens are built from nearly optically transparent tissue, they do pass less light at some wavelengths (mostly short) than others. In the literature, the prereceptoral filter (PRF) effects of the combination of the cornea and lens are usually modeled as a single lens density spectra. A good data set is on the web site [Stockman and Sharpe 2004]. (All instances of this reference herein implicitly also reference the original work: [Stockman and Sharpe 2000] and [Stockman et al. 1999].)

Some data exists on the individual effects of the cornea [van den Berg and Tan 1994]; in one embodiment of the system, this data is used to split the Stockman & Sharpe data into a separate cornea and lens spectral transmittance function. The data is given in an average spectral density form; it was normalized by the average path length that rays take within the models of the cornea and lens in order to get true spectral transmittance functions of physical optical path length.

### 15. Stiles-Crawford Effect

The Stiles-Crawford effect I (SCE-I) [Lakshminarayanan 2003] is the reduction of perceived intensity of rays of light that enter the eye away from the center of the entrance pupil. It is caused by the waveguide nature of the inner and outer segments of the retinal cones. It is generally thought to reduce the effect of stray (off axis) light due to scattering within the eye, and also to reduce chromatic aberration at large pupil diameters. While some implementations model scattered light by throwing it away, the chromatic effects are of considerable interest, so a simulation of SCE-I is included in some embodiments of the system.

The SCE-I is generally modeled as a parabola (in log space) as a intensity diminishing function η[r] of the radial distance r (in mm) from the center of the pupil that the light enters:
η[r]=e^{-pc·r}^{²}
where pc has the common literature value of 0.05 mm⁻².

In most systems, the SCE-I is modeled by an apodization filter: a radial density filter at the pupil. In some implementations of this model system, the SCE-I effect can be more accurately modeled at the individual cone level. This also allows a simulation of the 1° perturbations in relative orientation direction within the cones that is thought to occur. The standard equation above can be converted to a function of the angle φ relative to the orientation of an individual cone. With the optical model, empirically it was found that conversion from physical entrance pupil coordinates in mm to φ in radians is a linear factor of 0.047, ±0.005. After multiplying by the 1.13 physical to entrance pupil scale factor, this gives a simple first order rule of:

$$η [ φ ] = {ⅇ}^{- p c \cdot {( \frac{φ}{0.053} )}^{2}}$$

Some papers argue that the SCE-I is better modeled by a Gaussian (in log space) and that model can be used in other implementations. The parabolic function is used in one implementation as the 1° perturbations already change the overall effect.

### 16. Cone Photopigment Absorptance

Once a photon is known to enter a cone, the probability of it being absorbed depends on its wavelength λ, the type of cone (L, M, or S), and the width and length of the cone. Each cone type has its own absorbance (photopigment optical density) spectra function A[λ]. Variations in density due to the width and length of cones are modeled as a function D[θ] of eccentricity θ. Combining these gives us an absorptance function J[λ,θ] of wavelength and eccentricity:
J[λ,θ]=1−10^{-D[θ]*A[λ]}

Again for A[λ] the spectral data from [Stockman and Sharpe 2004] can be used for the L, M, and S cones. Their estimates of D[0] (at the center of the fovea): 0.5 for the L and M cones, and 0.4 for S cones were also used. By 10° eccentricity, D[θ] for L and M linearly falls to 0.38; By 13° eccentricity D[θ] for S falls to 0.2.

Only two thirds of photons that are absorbed by a photopigment photoisomerize the molecule. These photoisomerizations within the cone's outer segment start a chemical cascade that eventually leads to a photocurrent flowing down to the cone cell's axon and changing its output. The effects of this cascade can be fairly accurately modeled by a simple set of differential equations [Hennig et al. 2002], or the output can be even more simply approximated as a logarithmic function of the rate of incoming photons. While under ideal conditions as few as five photoisomerizations within a 50 ms window can be perceived, generally it takes at least 190 photoisomerizations within a 50 ms window to produce a measurable response. The linear in log space response of a cone occurs between 500 and 5,000 photoisomerizations per 50 ms; above this significant numbers (more than 10%) of cone photopigments are in a bleached state, and the cone cell's output becomes an even more non-linear function of light. Mimicking this effect is part of the process of producing high dynamic range images. However, as was shown above, sitting right next to a 2,000 lumen digital projector produced only about 1000 photoisomerizations per 16 ms per (foveal) cone, or about 3,000 photoisomerizations per 50 ms. Thus for the purposes of simulating the effects of display devices on the eye, the system generally operates in the simple logarithmic range, and in some embodiments does not simulate any non-linear saturation processes. There are many other suspected regional non-linear feed-back mechanisms from other cells on the retina to the cones that may affect the actual output produced by a cone. To separate out these effects, in one implementation, the system produces as output a per cone count of the photons that would have been photoisomerized by a population of un-bleached photopigments.

### 17. Wavefront Tracing and Modeling Diffraction

The quality of retinal images on the human eye are usually described as optical aberration limited when the pupil is open fairly wide (>3 mm), and as diffraction limited at the smallest pupil diameters (2-3 mm). Some authors (such as [Barton 1999] approximate both these PSF effects as Gaussians of specific widths, and then add these widths together to obtain a combined distortion Gaussian PSF. Unfortunately, this approach is too simplistic for accurate retinal images.

For many axial symmetric cases, optics theory provides simple (non-integral) closed form solutions for the PSF (Seidel aberrations, Bessel functions, Zemike polynomials). Unfortunately for the practical case of the living human eye, which is not even close to axial symmetrical, one usually must solve the integral solutions numerically on a case by case basis. Furthermore, because of loss of shift invariance, different PSFs preferably are custom calculated for every different small region of the retina [Mahajan 2001; Thibos 2000].

These PSFs are also different for different wavelengths of light. The PSF produced by defocused optics can produce some surprising diffraction patterns. For an example of a non-diffracted PSF versus a diffracted PSF, see FIG. 9 of U.S. Provisional Patent Application Ser. No. 60/647,494, “Photon-based Modeling of the Human Eye and Visual Perception,” filed Jan. 26, 2005, which has been incorporated herein by reference. A diffracted PSF can exhibit a hole in the center of the diffracted image: a point projects into the absence of light. While this strange pattern is reduced somewhat when a wider range of visible wavelengths are summed, it does not go away completely. (For some similar images, see p. 151 of [Mahajan 2001]). Thus, accurate PSFs of the eye cannot be approximated by simple Gaussians.

To numerically compute the diffracted local PSF of an optical system, a wavefront representing all possible photon paths from a given fixed source point through the system is modeled. When the wavefront re-converges and focuses on a small region of the retina, the different paths taken by different rays in general will have different optical pathlengths, and thus in general the electric fields will have different phases. It is the interference and support of these phases that determine the local PSF, representing the relative probability that a photon emitted by that fixed source point will materialize at a given point within the PSF. In one implementation, the paths of at least several thousand rays to the pupil simulated, and then in turn their several thousand each possible paths to the surface of the retina are simulated, pathlengths and thus relative phases computed, and then phases summed at each possible impact point.

Modern commercial optical packages have started supporting non axial symmetric diffracted optical systems; however for the system it was more convenient to create custom optics code optimized for the human eye. The optical code traces the refracted paths of individual rays of a given wavelength through any desired sequence of optical elements: the cornea, the iris, the lens, and to the retina. Along the way, wavelength specific losses due to reflection, scatter, and absorption are accumulated.

An array of diffracted PSFs is pre-computed for a given parameterized eye, accommodation, and display screen being viewed. Because the PSF is invariant to the image contents, and to small rotations of the eye, a single pre-computed array can be used for many different frames of video viewing. An array of PSFs only for the particular portion of the retina needed for a given experiment can also be pre-computed.

While parameterizable, in one embodiment 1024 randomly perturbed primary paths are traced from a source point to the pupil, and from each of these, the ray, pathlength, and phase to each of 128·128 points on the surface of the retina are computed. Thus PSF[p,λ] is the 128·128 probability density array for a given quantized display surface source point p and a given quantized frequency of light λ. The physical extent of the 128·128 patch on the retina is dynamically determined by the bounds of the non diffracted PSF, but is not allowed to be smaller than 20μ20μ in one embodiment. This means that at best focus the probability data is at 0.15μ resolution, allowing accurate rasterizing of photon appearance events onto 2.5μ·2.5μ polygonal outline cone optical apertures. Again while parameterized, in one example, λ is quantized every 10 nm of wavelength, for a total of 45 spectral channels covering wavelengths from 390 to 830 nm. In space, in one example, p is quantized for physical points on the display surface corresponding to every 300μ on the retina (1°). Photons are snapped to their nearest computed wavelength. The position of the center of the PSF is linearly interpolated between the four nearest spatial PSFs; the probability density function itself is snapped to the one of the closest PSFs. The accumulated reflection, scatter, and absorption loss: the prereceptoral filter PRF[P,λ], is associated with each PSF[P,λ], and is also interpolated between them in use.

For a simulation of more general viewing of the three dimensional world, PSFs from different distances in space as well as level of focus would be generated. However, in one embodiment, for simulations of the viewing of a flat fixed distance display surface, PSFs from different distances in space and levels of focus are not needed.

### 18. Eye Spectra

This section further describes spectral features of various elements of the human eye. As with other measurements of the human eye, many of these features are known to have various degrees of individual variation. The accuracy of the measurements also varies, and also as usual, many of the experimental measurements reported in the literature do not always agree.

This section first describes the conventions and definitions used in the literature as they relate to eye spectra. Then, the spectral characteristics of the cornea, the aqueous, the lens, the vitreous humor, the macula, and the photoreceptors of 3 cone types (and eventually rods) are described.

The book “Color Science: Concepts and Methods, Quantitative Data and Formulae”, second edition, by Wyszecki and Stiles for many years has been a good base reference for spectral tables, and is incorporated herein by this reference. Various papers over the years have proposed updates to many of the tables of data in this book. More recent experiments have generated better data for most of these tables. The website: cvrl.ucl.ac.uk has collected newer references as well as computer readable data for many of the spectral functions of interest. Most of the spectral data used in this eye model uses data from this web site at least as a starting point with some corrections applied.

i. Wavelength vs. Frequency

Most all the literature on the human eye characterizes spectral properties as a function of wavelength λ, usually measured in nanometers (nm). This choice means that amounts of light are measured in units of energy, and thus relative amounts of light, logs of various light values, etc. are all based on energy units.

However the interaction of light with human photopigments at some level must count the number of photons, and thus one cannot do all the bookkeeping in energy. Because the eye model is a photon mapper based system, it seems natural that the internal spectral properties and calculations should be based on frequency and photon count (and thus not wavelength and energy). This means that standard data typically will be converted into the appropriate units. To connect back to the literature, in much of the documentation, properties will be described in both ways. Routines that import data sets for table building will start out using the appropriate native units, the conversion to frequency and photon counts will be considered part of the import process, even for “imported” data that is actually represented as source code data initialization.

Frequency will generally be denoted by ν. In a vacuum, frequency and wavelength are related by their product being the speed of light (c):
frequency*wavelength=ν*λ=c=299,792,458 m/s

If frequency is measured in THz and wavelength in nm, then:
frequency*wavelength=ν*λ=c=299,792.458 nm THz

The use of wavelength based data also has the potential for error in use because technically the wavelength of light changes as the index of refraction change (while the frequency does not). However, so far it appears that most wavelength based data actually is expressed in index 1 (vacuum) converted form, which avoids the problem. (Otherwise the non-vacuum wavelength is properly the product of the vacuum wavelength times the index of refraction.)

ii. Index of Refraction

Simple materials have a single constant numerical index of refraction for a given frequency of light (usually denoted by the letter n, with appropriate subscripting). The index of refraction for all frequencies in a vacuum is 1, and for all other materials (with some exotic exceptions) it is a number greater than one. In some materials, the index of refraction may not be a constant, and change based on physical location. An important such example is the human eye lens. Such a gradient index (GRIN) lens can be modeled in a number of ways. Most simplistically (and most usually) by a lens with a constant index of refraction that otherwise has similar optical focusing properties. More sophisticatedly by an “onion” shell approach; nested shells of lenses each with an (increasing) constant index of refraction. The human eye has been modeled by models with 12 to 120 to 400 such shells. (The actual eye has about 2,500 shells of fibers with slightly different indices of refraction.) Finally, there are some truly continuous lens models of refraction index change. There also are some papers that speculate that the index of refraction of the fibers that make up the lens change their index of refraction somewhat as the lens changes thickness (accommodates).

It is often said that the speed of light passing through a material with an index of refraction n (ignoring frequency variations for the moment) slows down by a factor of n. This is used to motivate Snell's law, why rays of light refract (change direction of travel) when they encounter an interface between two materials with different indices of refraction. In reality the speed of light is always the same (c), but the group velocity of the radiation will be less by a factor of n; it is this group velocity that is associated with the movement of electromagnetic energy through the materials.

The frequency of light v does not change when the light traverses a material with an index of refraction n, but the effective wavelength does. Because the group takes n times longer to traverse the material than an equivalent spatial amount of vacuum, and because the frequency v does not change, it is as if the wavelength of the light had changed to be smaller by a factor of n. What is important is that the number of cycles that the wave makes as it passes through the material is increased by a factor of n over what it would have in a vacuum (see optical path length below).

While for simple computations the index of refraction can be taken as the same constant for all frequencies, in more detailed simulations it must be modeled as a function of frequency (wavelength).

Thus the formal terms used herein will be opticalPathLength, and when it is a function of frequency (or wavelength), opticalPathLength[ν] (or opticalPathLength[λ]).

iii. Optical Path Length

Unfortunately the term optical path length is used to refer to any of a variety of related measures. All of these refer to some linear metric of the path that a ray of light takes as it is refracted by different surfaces through materials with different indices of refraction. In the case of the human eye, the path of interest is the ray from the source of light through air (index 1.00029 for all visible frequencies) refracted by the air/front surface of the cornea, through the interior of the cornea, refracted by the rear surface of the cornea/aqueous, through the aqueous, refracted by the aqueous/front surface of the lens, through the lens, refracted by the rear surface of the lens/vitreous humor, and through the vitreous humor until terminating on the retina (past the macula to the front of a cone inner segment).

The spatial (or physical) path length is simply the real space summed distance that the ray travels, regardless of the frequency or any indices of refraction. While this is the actual space that the ray traverses, usually other forms of path lengths are used.
spatialPathLength=physical ray travel distance

The optical path length refers to a distance metric in which the spatial length of each segment is replaced by one larger by a factor of n, where n is the indexOfRefraction of the segment, for a given frequency. Because the number of cycles that a wave makes as it passes through these different segments will be enlarged by the segment's index of refraction, the optical path length can also be though of as the equivalent spatial path length through a vacuum that would have the same number of cycles. All this is important when comparing the relative phases of light that take different physical paths.
opticalPathLength[ν]=spatialPathLength*indexOfRefraction[ν]

While the above definition of optical path length is measured in units of distance (usually nm), for comparing relative phases sometimes it is more convenient to use phase units relative to a particular frequency ν: the optical path length in radians, or the optical path length in wavelength:
opticalPathLengthInRadians[ν]=opticalPathLength[ν]*2π/λ
opticalPathLengthInWavelengths[ν]=opticalPathLength[ν]/λ

Note that the literature is not always clear about which of these terms is being meant when the unqualified phrase “optical path length” is used. As noted, because the index of refraction is frequency dependent, all of the optical (non-spatial) versions of path length are (usually) thus also functions of frequency, and will have different values for different frequencies.

Optical path length (measured in distance, radians, or wavelengths) is also useful in expressing the differences between wavefronts of light; typically the difference between an “ideal” spherical wavefront, and the “real” distorted wavefront.

iv. Wavefront

The wavefront[ν] of a point source of light somewhere within an optical system is a surface of all points in space of a (given) constant opticalPathLength[ν] distance from the source. Thus because optical path lengths are frequency dependent, the wavefront surface in general will be different for each optical frequency. One of the points of this definition is that all points on a wavefront[ν] are in (absolute) phase with each other. Among other uses, wavefronts can be used in the computation of diffraction.

v. Definition: Transmittance

The transmittance of a light of a particular wavelength through a particular piece of material is defined as the fraction of light emerging from the material to that which entered it, ignoring reflection and some other effects. Thus transmittance can have values in the range [0 1]; where a transmittance of 0 means no light emerges, a transmittance of 1 means that all the light emerges, a transmittance of 0.93 means that 93% of the light emerges, etc. Formally:
transmittance(λ)=light_{OUT}(λ)/light_{IN}(λ)

The unitTransmittance is the transmittance of a unit thickness of a particular material and at a particular wavelength λ. If a material has a known unitTransmittance for a given unit, then a piece of that material x units in length will have a transmittance of:
transmittance(λ)=unitTransmittance(λ)^{x}

Values of unitTransmittance, just like transmittance, are always in the range of [0 1]. If the value of x is less than 1, then the value of transmittance will be greater. unitTransmittance, but note than x can never have a value of less than 0. (Note that the special case of 0 transmittance=never any light, is indeterminate.)

vi. Definition: Absorptance

Absorptance (as opposed to Absorbance, see below) is, in the absence of reflectance, just 1 minus the transmittance. When reflectance is included, all must sum up to 1:
Absorptance(λ)+transmittance(λ)+reflectance(λ)=1

vii. Definitions: Opacity

The opacity of a material at a particular wavelength is the reciprocal of the material's transmittance. The opacity values are always in the range of [1 infinity]. A transmittance of 1 (all light gets through) means that the opacity is also 1. A transmittance of 0.1 (10% of light gets through) means that the opacity value would be 10. Opacity values can never be less than 1, but are unbounded on the high side. Formally:
opacity(λ)=light(λ)_{IN}/light_{OUT}(λ)

viii. Definitions: Photographic Optical Density

The optical density of a material (more formally the photographic opticalDensity of a material) is the log₁₀ of the reciprocal of the material's transmittance, or the log₁₀ of the opacity, for a given wavelength.

$$\begin{matrix}optical Density ( λ ) = {log}_{10} ( 1 / transmittance ( λ ) ) \\ = {log}_{10} ( opacity ( λ ) ) \\ = {log}_{10} ( {light}_{IN} ( λ ) / {light}_{OUT} ( λ ) )\end{matrix}$$

A material with a transmittance of 1 (all light gets through) means that the opticalDensity value would be 0. A material with a transmittance of 0.1 (10% of all light gets through) (opacity 10) means that the opticalDensity value would be 1. A material with a transmittance of 0.01 (1% of all light gets through) (opacity 100) means that the opticalDensity value would be 2. Values of opticalDensity (assuming log₁₀) range from a minimum of 0 (all the light gets through) through arbitrary large numbers (for which exponentially less and less light gets through).

Reversing the above equation, for base 10 logs, the transmittance of a material is related to its opticalDensity by:
transmittance(λ)=10_{-opticalDensity(λ)}

Density as a working unit can be convent in that if two materials are stacked together, one with a density value of density 1, the other with a density value of density2, the correct combined density is density1+density2. The log representation also allows what would be very small transmittance numbers to be represented by larger numbers. The log representation is also convenient because standard photographic film is sensitive roughly the log of the exposed light level, rather than being linearly sensitive to light. Thus the opacity (“linear density”) of exposed photographic film is a measure of the opticalDensity of the original exposing light. This is why the term “photographic” is usually used as a qualifier in the definition.

Sometimes the log of opticalDensity is used (log₁₀ or otherwise): logOpticalDensity. If an opticalDensity function had been normalized to a maximum value of 1 (all opticalDensity values in [0 1]), then the logOpticalDensity) will have all negative values: all values in the range of [-infinity 0]. If one is used to thinking of opticalDensity values as working values, then taking the log of them seems fairly natural. But in terms of the transmittance, there really is a double log involved:
logOpticalDensity(λ))=log₁₀(log₁₀(1/transmittance(λ)))

This double log is apparently viewed as necessary when the first log (opticalDensity) is working on the wrong end of the log compression scale. Say for example that a human cone absorbs ⅔ of all the photons of its most sensitive wavelength (λₘₐₓ) that pass through it. This would be a transmittance(λₘₐₓ)=⅓. Thus the opticalDensity(λₘₐₓ) would be 0.176. But now let's run over to the (visible) frequency where the cone is at its least sensitive. Here nearly all the photons will get thorough, leading to a very high transmittance, close to unity. If say only one photon out of every 100,000 is absorbed, this would be a transmittance(λₘᵢₙ)=0.99999. Now the opticalDensity(λₘᵢₙ)=4.3*10⁻⁶, quite an inconveniently small number. Even after normalizing the peak opticalDensity to unity (divide all by 0.176), normalizedOpticalDensity(λₘᵢₙ)=2.5*10⁻⁵. The fundamental problem is that for values near unity, log₁₀(x) is close to linear in x, so no appreciable compression of the function takes place. Now if an additional log is taken, the numbers fall back into a nice small range:
logOpticalDensity(λₘₐₓ))=log₁₀(log₁₀(1/transmittance(λₘₐₓ))/0.176)=0
logOpticalDensity(λₘᵢₙ))=log₁₀(log₁₀(1/transmittance(λmin))/0.176)=−4.6

This is the functional transform used for most of the more recent work on opticalDensity. The older work nominally only used one log (opticalDensity), but then would plot spectral functions of it using a log axis (vertically)—so as far as the visual shape of the plot, they were the same as the double log: logOpticalDensity.

ix. Definitions: Absorbance

Absorbance (as opposed to Absorptance, see above) is generally a synonym of opticalDensity. Taking the log of absorbance, e.g. log₁₀(absorbance)=logAbsorbance, is the same as log₁₀(opticalDensity)=logOpticalDensity.

x. Spectral Characteristics of the Cornea Front Reflection

As an interface between two materials with different indices of refraction, the front surface of the cornea reflects back some of the incident light, as a function of the wavelength, angle of incident to the local corneal surface, and the polarization of the light. Let the angle of incidence be θᵢ and angle of refraction be θₜ. Then the general Fresnel equation is:

$$T = \frac{1}{2} [ \frac{{sin}^{2} ( {θ}_{i} - {θ}_{i} )}{{sin}^{2} ( {θ}_{i} + {θ}_{t} )} + \frac{{tan}^{2} ( {θ}_{i} - {θ}_{t} )}{{tan}^{2} ( {θ}_{i} + {θ}_{t} )} ]$$

The term involving sines is proportional to s-polarized light; that involving cosines p-polarized light.

In the simple case of unpolarized light at normal incidence, this reduces to:
R=(N^{cornea}−N^{air})²/(N^{cornea}+N^{air})²

For four sample wavelengths (and with N^{air}=1.00029) this gives:

TABLE 1

| λ | N^{cornea} | R |
|---|---|---|
| 458.0 | 1.3828 | 0.0257 |
| 543.0 | 1.3777 | 0.0251 |
| 589.3 | 1.3760 | 0.0249 |
| 632.8 | 1.3747 | 0.0248 |

These values are very close to the 2.5% reflectance given as an overall approximate to corneal lens reflection [Rodieck 1998, p. 73; van den Berg and Tan 1994, p. 1453].

For wide pupils some rays (that will go on to make it to the retina) will intersect the. cornea at reasonably high angles, and some types of displays can have significant polarization; in such cases the more general R equation can give values between 0% and 10% reflectance. But in most typical cases the overall effect of changes in R will be a fraction of a percent; so apparently the standard usage is to use a constant 2.5% reflection rate.

The eye model has all the terms to compute any of these three approximations. In one embodiment, the code uses the normal incidence approximation; in other embodiments that include additional support for polarized light, more complete Fresnel equation are included.

The modeling conventions of the past have included all spectral varying density functions before the macula as lumped into the lens density function. Thus when this convention is broken, potentially the standard lens density function has to be replaced with an updated lens density function with the separately modeled elements subtracted out. This applies even when changing the corneal reflectance model from a wavelength independent 2.5% reflectance to the wavelength dependent normal incidence approximation. Because the old lens data was taken over a field of 10 degrees or less in size and with (presumably) un-polarized light, updating to the full Fresnel equation should be able to use the same lens density correction that is used for normal incidence approximation. The corrections here are small, but the principle is important, as the corrections for corneal transmittance are not so small.

xi. Spectral Characteristics of the Cornea Transmission.

Rodieck 1998, p. 73] states that the cornea interior absorbs or scatters 9% of the light (at any frequency) that reaches the inside of the cornea (e.g. not reflected) (91% transmission), but how this number is arrived at is not explained in the notes.

The cornea material does have an optical density function, but because physical measurements usually confound cornea and lens density functions, “traditionally” the cornea density function is counted in the lens density function and otherwise ignored. If the model in [van den Berg and Tan 1994] is used for corneal transmittance, the lens density function will have to have an equivalent amount pre-subtracted out.

The [van den Berg and Tan 1994] corneal transmittance model is:
log₁₀(transmittance(λ))=−0.016−85*10⁸ nm⁴λ⁻⁴
or de-logged:
transmittance(λ)=10ˆ(−0.01−85*10⁸ nmλ⁻⁴)
where λ is the wavelength in nm. The constant used here is for direct transmittance (acceptance angle of 1 degree). Using an average cornea thickness, this can be turned into a unit transmittance factor. The −0.016 factor represents a 3.6% wavelength independent light loss. The paper appears to indicate that this transmittance function does not include the 2.5% reflectance loss at the front surface of the cornea.

As with other parameters for a standardized size reference eye, when the eye model is used to model eye physically larger or smaller than the reference, the cornea density has to be scaled properly. If the unit transmittance factor is invariant in eye size, then this is the right way to automatically scale.

xii. Spectral Characteristics of the Cornea Back Reflection

Because the indices of refraction of the cornea and the aqueous are so similar, the amount of back reflection is minimal (0.0002 at 543 nm). This is small enough to be ignored in some embodiments of the system.

xiii. Spectral Characteristics of the Aqueous

Traditionally the aqueous is considered clear enough to not affect light transport, and so spectral density functions for it are not considered in some embodiments of the system.

xiv. Spectral Characteristics of the Lens Front Reflection

Because the indices of refraction of the aqueous and the lens are so similar, the amount of back reflection is minimal (0.0009 at 543 nm). This is small enough to be ignored in some embodiments of the system.

xv. Spectral Characteristics of the Lens

The christline lens actually has a complex internal variable indices of refraction (even for a fixed wavelength). The data here is for a simplified homogeneous lens model.

The most recent data is from the [Stockman et al. 1999] corrections to [van Norren & Vos 1974]. The numeric values of the data from these papers as tabulated at the website: cvrl.ucl.ac.uk are used to initialize the lens specular data in the eye model.

The modeling conventions of the past has included all spectral varying density functions before the macula as lumped into the lens density function. Thus when this convention is broken, the standard lens density function is replaced with an updated lens density function with the separately modeled elements subtracted out.

There is also a Stockman 1993 (Table 7) correction to the [van Norren & Vos 1974] data. The [van Norren & Vos 1974] data itself is a correction to the “Optical density differences of the young human eye lens (completely open pupil) as a function of wavelength” in the first edition of [Wyszecki & Stiles 1967], and this correction appears side by side with the original in the second edition of [Wyszecki & Stiles 1982].

These earlier tables are actually presented as “density differences”, which mean that the values are relative to the optical density at 700 nm. To convert these relative densities to absolute densities, it is suggested that the best approximation is to add a value of 0.15 to the relative densities.

The data for these earlier publications is given as for “completely open pupil”; to use the data for a small pupil, it is suggested that the values be multiplied by 1.16, because of the difference in lens thickness encountered. By integrating actual ray tracing, it was found that the average lens thickness varies from 3.36 mm for an 8 mm diameter virtual entrance pupil, to 3.96 mm for a 2 mm diameter virtual entrance pupil. The ratio of these lengths is 1.178, not 1.16, but the difference is well within what would be expected when other factors are considered. The more recent [Stockman et al. 1999] data is relative to a small pupil (e.g. needs to be divided by a factor of 1.16 for a wide open pupil), so that data conversion step is no longer necessary.

Since this is an exact ray-tracer, the transmittance of a particular ray within the lens will be a function of the optical path length (the equation given in the opacity section); this would automatically take the 1.16 factor into account when a wide open pupil is used; more generally it will correct for any size pupil. The data for a particular wavelength λ is converted from relative densities for a small pupil (2 mm diameter) to transmittance per mm of travel by:
No need to multiply by 1.16—the new data is already for a 2 degree pupil.
Add 0.15 to convert to absolute density d for a nearly closed (2 mm diameter) pupil.
Next convert to unit transmittance (per mm) using the equation t=10^{-3.96/d}, where the 3.96 is the thickness of the center of the lens in mm. Remember to parameterize in scaled eyes.

During processing the spectral data is used as follows: Once a ray has traversed the lens, based on the ray's wavelength look up the appropriate unit transmittance per mm. Then raise this unit transmittance to the power of the known optical (physical) path length through the lens (in units of mm). The result can be viewed as the probability that this particular ray (of this particular wavelength traveling this particular distance through the lens) will not be absorbed or scattered by the lens, and continue through the eye (on the nominal path). Express this probability as a fraction p between 0 and 1. Generate a (uncorrected) random number between 0 and 1. If this number is above p, cull the ray and perform no further processing on it.

xvi. Spectral Characteristics of the Lens Back Reflection

Because the indices of refraction of the lens and the aqueous are so similar, the amount of back reflection is minimal (0.0009 at 543 nm). This is small enough to be ignored in some embodiments of the system.

xvii. Spectral Characteristics of the Vitreous Humor

Traditionally the vitreous humor is considered clear enough to not affect light transport, and so spectral density functions for it are not considered in some embodiments of the system.

xviii. Spectral Characteristics of the Macular Pigment

The “standard” macular data is the data from Table 2(2.4.6) p. 112 of [Wyszecki & Stiles 1982]. (This table assumes that the maximum optical density, occurring at 458 nm, has a value of 0.5.) However the data from [Bone et al. 1992] and the macular pigment density spectrum from [Stockman and Sharpe 2000] is more recent and appears more accurate. The numeric values of the data from these papers as tabulated at the website: cvrl.ucl.ac.uk are used to initialize the macular specular data in the eye model.

Estimates of the thickness and extent of the macular pigment place it well beyond the macula itself. The main macula is within 3.5 degrees of the foveal center (diameter 7 degrees) (or so, different references give different numbers, and it is clear that there are individual variations between different people), but the pigment only falls to a constant thickness, and remains there throughout the rest of the retina.

It is not altogether clear how to interpret the table of optical density together with estimates of overall macula thickness/density. What is desired is a transmittance (or absorption) function of wavelength and retinal eccentricity. It appears that the table gives absolute optical densities (assuming a base 10 log) of the macula near its peak thickness at the central 2 degrees of the fovea. In this case the computed transmittance values can be used directly for spectral transmittance through the macula in the foveal region; the values can then be scaled down to 0 as a linear function of radius from the fovea on the retina out to 3.5 degrees (or a different individual variation radius).

xix. Non-Spectral Characteristics of the Stiles-Crawford Effect of the First Kind

The Stiles-Crawford type effect of the first kind (SCE-I) is a situation in which the human perception of the brightness of a fixed amount of light varies dependent upon where in the virtual entrance pupil of the eye the light enters. Specifically there is a point (xc yc) on the virtual entrance pupil where the light past through appears brightest; at points further away from (xc yc) the light appears dimmer, even though the physical intensity of the light is unchanged. The effect is not always radially symmetric, but is many times approximated as if it is. In this simplified case, let r be the distance of a point (x y) on the virtual entrance pupil from the point (xc yc). The SCE-I is usually modeled by equations and data fits that relate the perceived intensity (or its log) to functions of r. In log space, the most common fit is to a parabola, though several papers argue that the data fits appear slightly better with a Gaussian. The most common equation, as expressed in perceptual intensity space n (not log), is:
n=e^{-pc*rˆ2}
where pc is the parabolic parameter fit, a common value is 0.05 mm⁻².

The effect is generally considered to be caused by a waveguide property of the individual cone photoreceptors. The apparent mechanism is that cones on the retina are oriented in the direction (within ± a degree or so) of the center of the virtual exit pupil of the eye. Then a waveguide property of the individual cone cones causes a fall-off in capture of light that is not oriented in the same direction. Simplistically, this can be thought of as photons coming from points offset from the center of the virtual exit pupil not being captured as efficiently when they pass at an angle through the cone.

While the above is the cause, the effect is two-fold. First, much of the not otherwise absorbed stray light in the eye will have a greatly diminished effect on cone light sensitivity, as most of it will arrive at a cone at angles well away from the main orientation angle. This is of less importance in the implementations of the eye model where stray light is not modeled other than as absorbed. The second effect is an equivalent of narrowing the effective size of the entrance pupil, as rays coming from points near the edge have a diminished probability of being sensed by the cones. This has some effect on chromatic aberration, though by how much is not agreed on in the literature. In simpler eye models, the SCE-I has been modeled as an apadopized (variable radial density) filter at the pupil.

There does appear to be some wavelength dependent properties as well (discussed in the next section).

For a retinal model, what is desired is a function at the cone level: a fall off in photon capture rate as a function of the difference in orientation of incoming light from the orientation of the individual cone (difference angle θ). While some models in the literature are expressed this way (Enoch used n=A(1+cos Bθ)²), most are parameterized as described above in terms of distances on the virtual entrance pupil.

The eye model is thus presented with two issues. First, for a model that prides itself on dealing with optical models so complex that the concept of a single virtual exit pupil is ill-defined, there is the question of how to orient the individual cones. Second, within the model the SCE-I has to be modeled as a function of the cone difference angle θ.

The cone orientation issue can be addressed by empirically computing an approximate virtual entrance pupil center for small individual patches of the retina during a pre-processing stage for each unique parameterized eye model. The idea is that one set of rays are passed through the model at a particular external entrance angle. Where these rays appear to focus on the (simulated) retina is determined. Given this point, a second set of rays from the same exterior angle is passed through, and all rays that land within a short retinal distance of the focus point (0.1 mm or less) have their normal direction vectors averaged. The average is normalized and negated. This is a normal vector pointing to the equivalent of the virtual exit pupil of the eye for cones nearby the focus point. There is some evidence that the human eyes establish the orientation of their cones in a similar fashion. This procedure is repeated at some number of points on the retina, with the resulting data then interpolated across the entire retina specifying the orientation for each individual model cone. (Per cone noise of ± one degree or so in the orientation is added to the model in one embodiment, the absolute amount can be an input parameter.) This is an outline of one method of computing the individual cone orientations; there are alternate versions that may be more efficient, and/or allow other pre-processing computation to be conducted in parallel.

The other issue is how to convert SCE-I functions or data from the literature that is expressed in entrance pupil distances into functions of individual cone difference angle θ. Again, for complex optical models one way is empirical computations. (Though given the individual variation in SCE-I the physical reality is more likely the other way around; real cones probably have a fairly fixed SCE-I function in terms of θ, but optics variations per individual eye cause the virtual entrance pupil SCE-I data to vary.) Empirically for the nominal parameters of one embodiment of the eye model, it was found that conversion from physical entrance pupil coordinates in mm to θ in radians is a linear factor of 0.047, ±0.005. A simple scale factor for conversion to virtual entrance pupil space is to multiply by 1.13, giving a simple first order rule of:
θ=0.053*r
where r is measured in mm, θ in radians. (This constant is similar to one of 2.5 degrees per mm found in the literature.) Thus a simple SCE-I cone model is:
n(θ)=e^{-pc*(θ/0.053})ˆ2
with a pc value of 0.05 mm⁻² common.

If instead a Gaussian model of the SCE-I is desired, the equations can be converted using equivalent half-widths of the parabolic model to the Gaussian. One concern about the Gaussian model is that it is partially justified “due to the perturbations in cone orientations”. But when modeling an individual cone (perturbed with respect to its neighbor, perhaps with different inner and outer segment lengths) such effects should not apply. So in some implementations, the eye model will use the above SCE-I parabolic equation.

There does appear to be some wavelength dependent variation in the value of pc. If pc is 0.05 at 670 nm, it may be 30% higher at 433 nm, and also higher above 670 nm. There is some indication that the values of pc are also slightly different for the three cone types.

If the SCE-I is not accounted for by an apadopized (variable radial density) filter at the pupil, then something has to be known about the probability distribution of ray angles to the retina. While this could be empirically computed and stored in a table, preliminary empirical simulations show (for narrow pupils) rays emerge from the virtual exit pupil with a fairly constant distribution (per frequency). (In one example the probability of rays of any angle that made past the pupil varied only from 33% to 32.2%, a relative difference of 2.5%.) So for one implementation of the eye model, when the incoming ray direction at the retina is simulated, it may be randomly chosen from a uniform probability distribution of rays within the (virtual) exit pupil. This randomly chosen ray can then be dotted with the particular normal vector of the particular cone hit, in order to compute (via arccosine) the angle for computing the SCE-I for that particular cone.

xx. Spectral Characteristics of the Stiles-Crawford Effect of the Second Kind

It is well known that the head on cross-sectional size of cone inner segments varies with retinal eccentricity (not quite radially); cones near the fovea are packed closer together. There is also an (approximate) constant volume effect; as cones increase in cross-sectional size, they decrease in length. Thus the longest cones are found near the center of the fovea; they get progressively shorter at greater retinal eccentricity. This makes sense if one thinks of cones as holders for somewhat equivalent numbers of photopigments, whatever their length.

But changing the width and length of cone inner (and outer) segments makes a difference in waveguide models of cone light absorption. Cones further from the retinal center will have different standing wave modes for different wavelengths, and less total length for the nodes in the modes to occur. Thus one might expect some variation not only in the SCE-I (above), but also some additional shifts in the color response of these different width and length cones. Such a shift is indeed found, and part of it is described as the Stiles-Crawford effect of the second kind (SCE-II).

There is also the possible factor of “screening” by the first sets of photopigments later encountered by light passing along a cone outer segment of photopigments encountered further along the cell.

Data sets for the SCE-II can also be translated into cone level spectral functions for the eye model. However this must be done with care, as this is entering into areas where other data sets may be applying inter-related corrections. Specifically spectral characteristics of individual photo receptor (cone) types (described further in the next section) have some corrections for broadening of their spectral response curves at greater eccentricities.

xxi. Spectral Characteristics of the Individual Photoreceptors

Human color vision rests on only three types of color receptors. Thus, in theory, given detailed spectral data about any particular stimulus light, it should be possible to predict what color sensation the light will produce in a human observer (where sensation is defined as being able to specify all the other spectral combinations of colors that would produce a color the human would name as “the same”). Such a predictor is called a “color matching function” (CMF). In practice, accurate CMFs have turned out to be very hard to determine. A series of these have been produced over the years, the most important of which have been the various CIE and more recent Stockman and Sharpe CMFs. These models produce what are called “spectral sensitivity functions”.

It is now known that there are individual differences, so that there is no such thing as a universal CMF that will work for all individuals; the current models focus on an idealized observer.

The CMF's do a great job if one is treating the eye as a black box system; external light goes in, color sensation comes out. This functionality is just what is wanted in the majority of real-world applications. In an eye model that has already separately taken into account the spectral effects of the cornea, lens, and macula, what is wanted is a raw cone specular response.

At the raw cone level, what one wants to know about a particular cone (of a particular type, L, M or S), is what is the probability p(λ) that a single photon (with a wavelength λ), that enters the inner segment of that cone, will be captured and “sensed” by that cone, assuming that the cone is operating in its linear (non-bleached) range. This is modeled by a cone “optical density function” that relates the relative probability that a given cone type will absorb (vs. pass through) a photon of a given wavelength.

Such cone optical density functions can be derived from CMF's, by subtracting out the spectral effects of the other parts of the eye system. These include the lens (which really means the cornea and lens), and the spectral effects of the macula. The amount to be subtracted out varies with radial eccentricity (that is why there is “2 degree” and “10 degree” CMFs). This is because it turns out that the change in width and length of the cones from the fovea to portions of the retina further from the center also changes the response of the cones, likely due to difference of “standing wave” modes of the cones. Indeed conversion to “raw” cone functionality is done as part of the process of building CMS from observer data, in order to back-out any “non-standard” lens or macula variation in individual observers.

Thus raw cone opticalDensity functions are available as part of these past studies. The data is generally given in the form of log₁₀[A[λ]], where the optical density function A[λ] has been normalized to unity at the most sensitive wavelength (e.g. log data value zero). To convert this into what is wanted, the probability that a photon of wavelength λ will be converted into a sensation, a peak photopigment opticalDensity value D[θ] must be known, and then the conversion is straightforward. Convert the absolute optical density to transmittance, then to absorptance, which is the probability wanted:
J(λ)=1−10^{-D[θ]*A(λ)}

However D[θ] does not have a constant value, even for an individual cone type. It appears to vary with cone width and length, which varies with radial eccentricity θ, and by individual. The D[θ] values assumed by Stockman and Sharpe near the center of the fovea (2 degrees) were 0.5 for L and M, and 0.4 for S. At 10 degrees, the 0.5 D[θ] values for L and M was assumed to fall to 0.38. At 13 degrees, the D[θ] value of 0.4 for S was assumed to fall to 0.2.

For an eye model for which each and every cone can have individual parameters, more complex variations can be supported. One must be careful not to multiple correct for the same effect; for example the retinal eccentricity variations in D[θ] are at least part of the explanation of the Stiles-Crawford type effect of the second kind.

One also must be careful of defining “sensed”. Only two thirds of photons absorbed by a photopigment isomerize the molecule, and only 80% of these isomerized molecules will start the biological cascade to actually effect the electrical polarization of the cone base. This can be handled separately, or folded into a combined capture function by modifying D[θ].

So it must be acknowledged that the absolute coupling constant for photons into cones may not be absolutely known, but only known to within a small constant range. This is not too important of drawback, as at the end of the day the eye simulator, like the real eye, only cares about relative sensation levels.

### 19. System Results

The following section describes the operation of the system in procuring results and describes the system results. The first step is to parameterize and synthesize a retina. The same parameterization is then used to interactively adjust the optics (including focus) and the working distance of the simulated display surface; this results in locking down all the optical parameters needed for the next step: computing the array of diffracted PSFs. Those in turn are used as input by the photon simulation. Given the parameters of display surface sub-pixel elements, a frame of video pixels to display, and an eye drift rotation during this frame, the emission of every photon that would occur during this time frame can be simulated (at least those that might enter the eye). Each simulated photon created is assigned a specific point p in space, t in time, and wavelength λ. p is randomly generated from within the sub-pixel display surface element extent. t is randomly selected from within the time interval of the temporal characteristics of the specific display device. λ is randomly generated from within the weighted spectral probability distribution of the display device sub-pixel type. In an alternate embodiment, in addition to these properties, a simulated photon also has an appropriately synthesized polarization state for the type of display simulated.

The quaternions that represent the endpoints of the drift can now be used to interpolate the orientation of the eye given t. This is used to transform p to the point p′ on the display surface where the eye would have seen p had no rotation occurred. Using quantized λ and p′, PSF[p′,λ] and PRF[p′,λ] can be found, as well as the three closest neighboring values of each. After interpolating these PRFs, the sum effects of all the prereceptoral filters (cornea, lens, macula) for the photon can be expressed as the probability of the photon never reaching past the macula. A random number in the range [0 1) is generated, and if it is below this probability this photon is discarded. Otherwise, the center of the landing distribution for the photon is computed by interpolating the centers of the four PSFs by their relative distances from p′. The 128·128 PSFs are actually represented as an accumulated probability array. In this way, a random number is generated and then used to search the 128·128 table until the entry closest to, but not above the random value is found. The associated (x y) location in the table is the location at which this photon will materialize. Using the known retinal center point of the interpolated PSFs, and a 2D scale and orientation transform associated with the PSF, this (x y) location can be transformed to a materialization point on the retinal sphere.

Using spatial indices and polygonal cone aperture outlines imported from the original synthesis of the retina, a list of candidate cones that might contain this point is generated. All candidate cones use plane equations of their polygonal entrance to see if they can claim this photon. If it falls outside all of them (e.g., hit the edge of a cone, or a rod, or a void), the photon is discarded. Otherwise the unique cone owning the photon subjects it to further processing. The individual (perturbed) orientation φ of the cone is used to determine the probability that the SCE-I η[φ] will cause the photon to be rejected. Otherwise, the photon is subjected to its final test: the probability of absorptance J[λ,θ] by a photopigment in this particular type of cone (L M or S) of a photon of wavelength λ. Now a random number generated with a lower value than this probability will cause this particular cone to increment by one the number of photons that it has absorbed during this frame.

This process repeats for all photon emission events for each frame of the simulated video sequence. At the end of each frame, the cone photon counts are output to a file. These files are used to generate visualizations of the results by using each cone's photon count to set a constant fill intensity level of its polygonal aperture, normalized by the aperture's area, and the maximum photon count. (And the image is inverted and flipped left to right.) For examples of figures generated this way, see FIGS. 10-12 of U.S. Provisional Patent Application Ser. No. 60/647,494, “Photon-based Modeling of the Human Eye and Visual Perception,” filed Jan. 26, 2005, which has been incorporated herein by reference. A complex simulated eye can be tested by showing an eye chart. Viewed just using light at the chosen focus wavelength, the 20/12 acuity line is mostly readable; with broader spectrum illumination acuity drops to 20/15. This is consistent with normal human vision of between 20/10 and 20/20. For a variable spatial frequency 100% contrast sine-wave test at 543 nm light, the result is similar to the normal human cut-off of 40-60 cycles/degree.

When the effect of motion blur due to drifts is enabled, a comparison of blurred and un-blurred images can be made. Five consecutive frames from a 30 minute per second drift motion blur rendering of the same 20/12 line are compared to the un-blurred image. Any one of these five frames is blurrier and less legible than the un-blurred one. However, when the five frames are averaged together, the average image is actually more legible than the un-blurred one. This supports a suspected reason why the human eye has a slow drift: imaging the same external object onto different cone sampling patterns results in the visual system getting a better resolution view of the object.

These sorts of averaging over blur and realistic cone sampling patterns is one use of the system described herein. The actual averaging that the visual system (and the simulator) does is more sophisticated. It involves processing retinal receptor fields of cone outputs, and processing visual cortex spatial/temporal receptor fields of those outputs.

### 20. Validation

In one embodiment, the lens model is a simple variant of a previous published and validated model in order to remove the optics as a validation issue. With non-diffracted rays, the same scatter plots at various eccentricities were obtained using the model as in the original paper [Escudero-Sanz 1999]; these did not change appreciably after lens decentering and accommodation to a closer focal distance. The generalized diffraction calculations generate similar PSFs as other published work [Mahajan 2001].

The synthesized retinas of the present invention have the same neighbor fraction ratio (6.25) as studies of human retinas. The density of cones/mm² measured empirically in the output of the synthesizer matches the desired statistics from [Curcio et al. 1990], except for a scale offset in the fovea where a target of 125,000 cones/mm² was set to obtain the 150,000 cones/mm² desired; this was likely due to packing pressure.

### 21. Alternate Embodiments

The system as described above has most of the mechanisms necessary to also simulate scotopic (rod) vision. The retinal synthesizer has a 4 GB working set just dealing with the live growth ring of the first 2.7 million cones; with some additional effort the 80 million rods can also be synthesized. In alternate embodiments, more complex surface shapes can be used for the optics and retina. The system already generates receptor fields of cones. In alternate embodiments, simulation of current models of some of the rest of the layers of retinal circuitry (such as [Hennig et al. 2002]) could be added; beyond that lies the LGN and the simple and complex cells of the visual cortex. If extended to visual cortex, simulating accurate cone photon counts for two eyes allows for interesting stereo simulations. Stereo simulations typically would also involve simulating focus and vergence of the eyes. While color vision theory has its own complications, superbly accurate spectral information up to the cone level (of each cone type) is maintained in embodiments of this model.

Although the invention has been described in considerable detail with reference to display devices, other implementations and applications will be apparent. For example, the photon-based model can be used to simulate visual perception situations other than just a human viewing a display device. It can also be applied in a similar way to all the elements in the image sequence production pipeline, all the way back to the image generation devices (e.g., physical cameras or computer graphics).

### 22. References

All of the following are hereby incorporated by reference in their entirety.
AHUMADA, A, AND POIRSON, A. 1987. Cone Sampling Array Models. J. Opt. Soc. Am. A 4, 8, 1493-1502.
ATCHISON, A., AND SMITH, G. 2000. Optics of the Human Eye. Butterworth-Heinemann.
BARSKY, B. 2004. Vision-Realistic Rendering: Simulation of the Scanned Foveal Image from Wavefront Data of Human Subjects. First Symposium on Applied Perception in Graphics and Visualization, 73-81.
BARTEN, P. 1999. CONTRAST SENSITIVITY OF THE HUMAN EYE AND ITS EFFECTS ON IMAGE QUALITY. SPIE.
BONE, R. A., LANDRUM, J. T., CAINS, A. 1992. Optical Density Spectra of the Macular Pigment in Vivo and in Vitro. Vision Res., 32(1), 105-110, January.
VAN DEN BERG, T., AND TAN, K. 1994. Light Transmittance of the Human Cornea from 320 to 700 nm for Different Ages. Vision Research, 34, 1453-1456.
COOK, R. 1986. Stochastic Sampling in Computer Graphics. ACM Transactions on Graphics, 5, 1, 51-72. See also U.S. Pat. Nos. 4,897,806, 5,025,400 and 5,239,624
COOK, R, CARPENTER, L, and CATMULL, E. 1987. The Reyes Image Rendering Architecture. In Computer Graphics (Proceedings of SIGGRAPH 1987), 21, 4 ACM, 95-102.
CURCIO, C., ET AL. 1990. Human Photorecptor Topography. J. Comparative Neurology 292, 497-523.
DEERING, M. 1998. THE LIMITS OF HUMAN VISION, IN 2ND INTERNATIONAL IMMERSIVE PROJECTION TECHNOLOGY WORKSHOP.
DOBKIN, D., EPPSTERN, D., AND MITCHELL, D. 1996. Computing the Discrepancy with Applications to Supersampling Patterns. ACM Transactions on Graphics, 15, 4, 354-376.
ENGBERT, R., AND KLIEGL, R. 2004. Microsaccades Keep the Eyes' Balance During Fixation. Psychological Science Volume 15(6), 431, June.
ESCUDERO-SANZ, I. 1999. Off-Axis Aberrations of a Wide-Angle Schematic Eye Model. J. Opt. Soc. Am. A, 16, 1881-1891.

FRY, G. A., AND HILL W. W. 1962. The Center of Rotation of the Eye. Am. J. Optom. 39, 581-595.
GEISLER, W. 1989. Sequential Ideal-Observer Analysis of Visual Discriminations. Psychological Review, 96, 2, 267-314.
GLASSNER, A. 1995. Principles of Digital Image Synthesis. Morgan Kaufmann.
HASLWANTER, T. 1995. Mathematics of Three-Dimensional Eye Rotations. Vision Research, 35, 1727-1739.
HALSTEAD, A., BARSKY, B., KLEIN, S., AND MANDELL, R. 1996. Reconstructing Curved Surfaces from Specular Reflection Patterns Using Spline Surface Fitting of Normals. Proc. ACM SIGGRAPH 1996 23, Annual Conference Series, 335-342.
HENNIG, M, FUNKE, K., AND WÖRÖGTTER, F. 2002. The Influence of Different Retinal Subcircuits on the Non-linearity of Ganglion Cell Behavior. The Journal of Neuroscience, 22, 19, 8726-8738.
LAKSHMINARAYANAN, RAGHURAM, A., AND V, ENOCH, J. 2003. The Stiles-Crawford Effects. Optical Society of America.
LIOU, H., AND BRENNAN, N. 1997. Anatomically Accurate, Finite Model Eye for Optical Modeling. J. Opt. Soc. Am. A 14,8, 1684-1695.
MAHAJAN, V. 2001. Optical Imaging and Aberrations: Part II Wave Diffraction Optics. SPIE.
MARTINEZ-CONDE, S., MACKNIK, S. L., AND HUBEL, D. H. 2004. The Role of Movements in Visual Perception. Nature Reviews Neuroscience 5, 229-240, March.
VAN NORREN, D. AND VOS, J. J. 1974. Spectral Transmission of the Human Ocular Media. Vision Res., 14, 1237.
OYSTER, C. 1999. The Human Eye: Structure and Function. Sinauer.
POLYAK, S. L. 1941. The Retina. Univeristy of Chicago Press.
POYNTON, C. 2003. DIGITAL VIDEO AND HDTV. MORGAN KAUFMAN.
RATLIFF, F., AND RIGGS, L. A. 1950. Involuntary Motions of the Eye During Monocular Fixation. J. Exp Psychol., 40(6), 687-701.
RODIECK, R. 1998. The First Steps in Seeing. Sinauer.
ROORDA, A., METHA, A., LENNIE, P, WILLIAMS, D. 2001. Packing Arrangements of the Three Cone Classes in Primate Retina. Vision Research, 41, 1291-1306.
ROORDA, A., WILLIAMS, D. 2002. Optical Fiber Properties of Individual Human Cones. Journal of Vision, 2, 404-412.
ROORDA, A., WILLIAMS, D. 1999. The Arrangement of the Three Cone Classes in the Living Human Eye. Nature, 397, 520-522.
SMITH, G. 2003. The Optical Properties of the Crystalline Lens and their Significance. Clinical and Experimental Optometry, 86,1, 3-18.
STEINMAN, R. 1996. Moveo Ergo Video: Natural Retinal Image Motion and its Effect on Vision. In Exploratory Vision: The Active Eye. Springer Verlag.
STENSTROM, S. 1946. Untersuchungen uber die Variation und Kovariation der optischen Elements des menschlichen Auges. Acta Opthal. (Copenh.) Suppl. 26. Translation by Woolf, D. 1948. Investigation of the Variation and the Correlation of the Optical Elements of Human Eyes. Am J. Optom., 25, 218-232, 286-299, 340-350, 388-397, 438-449, 496-504.
STOCKMAN, A., SHARPE, L., AND FACH, C. 1999. The spectral sensitivity of the human short-wavelength cones. Vision Research, 40, 1711-1737.
STOCKMAN, A., AND SHARPE, L. 2000. Spectral sensitivities of the middle- and long-wavelength sensitive cones derived from measurements in observers of known genotype. Vision Research, 39, 2901-2927.
STOCKMAN, A., AND SHARPE, L. 2004. Colour & Vision Database. http://cvrl.ucl.ac.uk/.
THIBOS, L. N. 2000. Formation and Sampling of the Retinal Image. In Seeing, Karen K. De Valois, Ed., Academic Press, 1-54.
THURTELL, M. J., BLACK, R. A., HALMAGYI, G. M., CURTHOYS, I. S., AND Aw, S. T. 1999. Vertical Eye Position-Dependence of the Human Vestibuloocular Reflex During Passive and Active Yaw Head Rotations. Neurophysiol, 81, 2415-2428.
TYLER, C. 1997. Analysis of Human Receptor Density, in Basic and Clinical Applications of Vision Science, Ed. V. Kluwer Academic Publishers, 63-71.
WALSH, G., AND CHARMAN, W. N. 1988. The Effect of Pupil Centration and Diameter on Ocular Performance. Vision Res., 28(5), 659-665.
WILSON, M. A., CAMPBELL M. C. W., SIMONET, P. 1992. Change of Pupil Centration with Change of Illumination and Pupil Size. Optom Vis Sci., 69(2), 129-136, February.
WYATT, H. 1995. The Form of the Human Pupil. Vision Research, 35, 14, 2021-2036.
WYSZECKI, G. AND STILES, W. S. 1967. Color Science: Concepts and Methods, Quantitative Data and Formulae, 1^{st} Ed. John Wiley & Sons.
WYSZECKI, G. AND STILES, W. S. 1982. Color Science: Concepts and Methods, Quantitative Data and Formulae, 2^{nd} Ed. John Wiley & Sons.

What is claimed is:

1. A method for simulating effects of a display device on a human eye, comprising:
simulating a propagation of light from the display device into the human eye;
simulating a motion of the human eye; and
predicting a perceived image based on interaction of the light propagation and the eye motion.

2. The method of claim 1 wherein the step of simulating motion of the human eye comprises simulating rotations due to saccades of the eye.

3. The method of claim 1 wherein the step of simulating motion of the human eye comprises simulating pursuit movements of the eye.

4. The method of claim 1 wherein the step of simulating motion of the human eye comprises simulating microsaccades of the eye.

5. The method of claim 1 wherein the step of simulating motion of the human eye comprises simulating slow drifts of the eye.

6. The method of claim 1 wherein the step of simulating motion of the human eye comprises simulating tremor of the eye.

7. The method of claim 1 wherein the step of simulating motion of the human eye comprises simulating a focusing of the eye.

8. The method of claim 1 wherein the step of simulating motion of the human eye comprises simulating vergence of the eye.

9. The method of claim 1 wherein the step of predicting a perceived image accounts for effects due to motion blur of the retinal image.

10. The method of claim 1 wherein the step of predicting a perceived image accounts for time of emission of light from the display device relative to the motion of the eye.

11. The method of claim 1 wherein the step of predicting a perceived image further comprises simulating layers of retinal circuitry beyond the cones.

12. The method of claim 1 wherein the step of predicting a perceived image further comprises simulating effects of the visual cortex.

13. The method of claim 1 wherein the step of simulating propagation of light from the display device into the human eye comprises simulating discrete light propagation events from the display device into the human eye.

14. The method of claim 13 wherein the discrete light propagation events include propagation of photons.

15. The method of claim 14 wherein the step of simulating propagation of photons from the display device into the human eye comprises calculating probability density fields for the photons on a surface of a retina.

16. The method of claim 15 wherein the step of simulating propagation of photons from the display device into the human eye further comprises converting the probability density fields into photon counts at photoreceptor cones of the retina.

17. The method of claim 14 wherein each photon is characterized by a location on the display device from which the photon is emitted, a time of emission, and a wavelength.

18. The method of claim 17 wherein each photon is further characterized by a polarization state.

19. The method of claim 14 wherein the step of predicting a perceived image based on interaction of the light propagation and the eye motion comprises predicting a location on the retina at which the photon arrives and a position of the human eye at the time of arrival.

20. The method of claim 1 wherein the step of simulating propagation of light from the display device into the human eye comprises:
generating a synthesized retina; and
simulating propagation of light from the display device to the synthesized retina.

21. The method of claim 20 wherein the synthesized retina includes individual photoreceptor cones and the step of simulating propagation of light includes simulating propagation of light from the display device to the photoreceptor cones.

22. The method of claim 20 wherein the synthesized retina includes individual photoreceptor rods and the step of simulating propagation of light includes simulating propagation of light from the display device to the photoreceptor rods.

23. A software product comprising instructions stored on a computer readable medium, wherein the instructions cause a processor to simulate effects of a display device on a human eye by executing the following steps:
simulating a propagation of light from the display device into the human eye;
simulating a motion of the human eye; and
predicting a perceived image based on interaction of the light propagation and the eye motion.

24. The software product of claim 23 wherein the step of simulating propagation of light from the display device into the human eye comprises simulating propagation of photons from the display device into the human eye.

25. The software product of claim 23 wherein the step of simulating propagation of light from the display device into the human eye comprises:
generating a synthesized retina; and
simulating propagation of light from the display device to the synthesized retina.

26. A software product comprising instructions stored on a computer readable medium, wherein the instructions cause a processor to assist in a design of a display device by executing the following steps:
simulating a propagation of light from the display device into a human eye;
simulating a motion of the human eye;
predicting a perceived image based on interaction of the light propagation and the eye motion; and
improving a design of the display device based on the predicted perceived image.
